(19) United States
(12) Patent Application Publication
(10) Pub. No.: US 2005/0109621 A1
(43) Pub. Date: May 26, 2005

(54) Method and apparatus for performing high-voltage contactless conductivity (HV-CCD) electrophoresis

(75) Inventors: Peter C. Hauser, Basel (CH); Eva Maria Abad Villar, Oviedos (ES); Jatisai Tanyanyiwa, Basel (CH)

Correspondence Address: GRIFFIN & SZIPL, PC, SUITE PH-1, 2300 NINTH STREET, SOUTH, ARLINGTON, VA, 22204, US

(73) Assignee: Peter C. HAUSER, Basel (CH)

(21) Appl. No.: 10/721,758

(22) Filed: Nov. 26, 2003

(51) Int. Cl. G01N 27/453

(52) U.S. Cl. 204/451; 204/601

(57) ABSTRACT

A chip-based capillary electrophoresis assembly including: a holder including a frame for removably receiving a chip; a capillary electrophoresis microchip dimensioned to fit onto the holder, and comprising a body and a separation channel defined in the body; and a pair of adhesive detection electrodes integrated with an electronic conductometric detection circuit, wherein the assembly is assemblable by disposing the capillary electrophoresis microchip on the holder and removably placing the adhesive electrodes on the microchip body near the separation channel. A label-free analyte conductometric detection method and a label-free capillary electrophoresis immunoassay method are also described.

### FIELD OF THE INVENTION

The present invention relates to a method and apparatus for performing high-voltage contactless conductivity (HV-CCD) electrophoresis. The invention also relates to several specific applications of the method and apparatus including, for example, label-free immunoassays.

### BACKGROUND OF THE INVENTION

Microfabricated analytical systems, also known as “lab-on-chip” devices, have recently and dramatically changed the way biochemical and chemical assays are performed. In particular, there has been much interest in micromachined capillary electrophoresis (CE) chips because of their fast and efficient capability to separate certain analyte species. Microfluidic devices utilizing laser-induced fluorescence (LIF) dominated this field a few years ago, but this technology was limited to systems that could detect species derivatized (i.e., labeled) to render them fluorescent. Alternative electrochemical systems and methods directed to amperometry, potentiometry and conductometry have been tried to expand the range of biochemical and chemical species detectable using micromachined CE chips. On the other hand, standard UV absorption techniques are generally not applied to capillary electrophoresis on chips because the available optical path lengths are too short to make UV techniques practical in this environment.

Conductometric detection systems and methods have enjoyed recent advances because conductometric techniques can detect the broadest range of analyte species. Specifically, conductometry is based on the same electrophoretic mobility property as the separation itself. Amperometric detection is limited to only electroactive species and not much interest has been present in potentiometric techniques.

While research groups Zemann et al. (Anal. Chem.1998, 70, 563-567) and da Silva and do Lago (Anal. Chem. 1998, 70, 4339-4343) were the first to independently introduce capacitively coupled contactless conductivity detectors (C⁴D) to the art of conductometric detection, Wang and coworkers (Pumera et al., Anal. Chem. 2002, 74, 1968-1971) have recently shown that capacitively coupled contactless conductivity detection is applicable to the chip format. As shown in FIG. 17 hereto, Wang's microchip electrophoretic detection system utilizes a microfabricated microfluidic chip device 1 made of polymethylmethacrylate (PMMA). This component of the system includes a separation channel 3 formed in the body of the device 1. Channel 3 is contiguous with the run buffer reservoir 5, a first sample reservoir 7, a second unused reservoir 9, and an outlet reservoir 11. Two aluminum foil electrodes 13 are glued to the surface of the device 1 by epoxy, and a thin copper wire (not shown) is glued to each electrode 13 using a conducting epoxy.

Wang's microchip electrophoretic detection system also includes a contactless electronic detector circuit 20, as shown in FIG. 18 hereto, which is connected to the sensing electrodes 13. The detector circuit 20 includes (a) a sinusoidal signal function generator 21 having a frequency of 200 kHz and a 5 V peak-to-peak amplitude (abbreviated “Vₚ₋ₚ”), (b) thin copper wires for connecting to the sensing electrodes 13, (c) electronics 25 described by da Silva and do Lago, (d) a filter provided by resistor R and capacitor C, (e) a voltage follower 27, and (f) an output 29 to a data acquisition system. Wang reported that the most favorable signal-to-noise characteristics of detector circuit 20 occurred at a voltage of 5 Vₚ₋ₚ, although he experimented with the amplitude range of 0-15 Vₚ₋ₚ only to discover that amplitude variation from 5 Vₚ₋ₚ resulted in a nearly linear increase in the noise level and in a reduced baseline stability.

In use, reservoirs 5, 9 and 11 are filled with electrophoretic run buffer solution, and sample reservoir 7 is filled with target ions, such as potassium, sodium, barium and lithium cations or chloride, sulfate, fluoride, acetate and phosphate anions, also dissolved in the run buffer. A separation voltage of +500V for cations or −500V for anions is applied between sample reservoir 7 and grounded outlet reservoir 11 for 3 seconds. This drives the “plug” into the separation channel. Subsequently, the separation voltage is applied between run buffer reservoir 5 and outlet reservoir 11 with all other reservoirs floating. Analytical analyte detection is then performed by applying the sinusoidal ac voltage of 200 kHz at around 5 Vₚ₋ₚ to electrodes 13.

While Wang's prior art microchip detection system adequately separates out cations and anions by capillary electrophoresis and provides the advantages of a relatively low cost integrated PMMA chip/detection system, Wang's system has several drawbacks.

The first drawback to the prior art micromachined capacitively coupled contactless conductivity detection (C⁴D) system is that the electrodes 13 are glued to the surface of the chip device 1. As a result, each time a new chip is to be used, the electrodes 13 on the chip must be glued to the chip and attached (i.e., soldered) to the copper wires of the detector circuit 20, which is time intensive and consequently expensive. Furthermore, if the electrodes are accidentally misplaced on the chip during the attachment process, it is not a simple matter to relocate the electrodes.

A second drawback to the prior art micromachined C⁴D system is that there is no shielding between the electrodes. Although some shielding in the form of a box is provided for the entire detector circuit 20, significant direct coupling between the actuator electrode and the pick-up electrode occurs and creates considerable background noise. This becomes more noticeable as larger amplitude peak-to-peak voltages are used.

A third drawback to the prior art micromachined C⁴D system is that it is limited in its conductometric detection sensitivity due to the relatively low 5-10 Vₚ₋ₚ applied during analytic separation. The prior art microchip C⁴D system was found to be limited to this peak-to-peak voltage range because higher amplitudes resulted in unacceptable noise levels and a reduced baseline stability. Consequently, the use of higher peak-to-peak voltages is not practical using the electronic circuitry of the prior art system. As a result, estimated detection limits of 1.2-8.1 μM for small cations and anions appears to be the limit of sensitivity for the prior art microchip C⁴D system and application to larger anions and cations is less sensitive.

A fourth drawback to the prior art micromachined C⁴D system is that it has not been shown to be useful for the conductometric detection of a broad range of molecules larger than small cations and anions, such as small alkaline and alkali earth metal cations and halogen anions. Recent experiments by Wang and coworkers has shown that his microchip C⁴D system is useful in detecting organophosphate degradation products of nerve agents (Anal. Chem. 2002, 74, 6121-6125) and explosive-related cations and anions (Analyst 2002, 127, 719-723). However, there remains a need for an improved microchip C⁴D system that can detect larger organic and inorganic molecules such as are used as pharmaceuticals, in immunoassays, and the like.

The present invention endeavors to provide an improved micromachined capacitively coupled contactless conductivity detection method and system utilizing high-voltage contactless conductivity (HV-CCD) that maintains the advantages of the prior art low-voltage microchip C⁴D system while overcoming the limitations of these prior art systems.

Accordingly, one object of the present invention is to overcome the limitations of the prior art microchip low voltage C⁴D systems.

Another object of the present invention is to provide a micromachined C⁴D system and method that utilizes HV-CCD so as to expand the range of detectable cations and anions to include larger organic and inorganic molecules such as organic acids, amino acids, pharmaceuticals and immunoglobulins.

Another object of the present invention is to provide a high-voltage microchip C⁴D system that has adhesive detection electrodes integrated with an electronic conductometric detection circuit separated from the capillary electrophoresis chip, which reduces the cost of manufacturing disposable electrodeless electrophoresis chips.

Another object of the present invention is to provide a high-voltage microchip C⁴D system that is constructed with detection electrodes integrated with an electronic conductometric detection circuit separated from the capillary electrophoresis chip, wherein the detection electrodes are constructed to be a permanent part of the chip holder.

Another object of the present invention is to provide a high-voltage microchip C⁴D system and method wherein the capillary electrophoresis chip is constructed to facilitate the placement of adhesive electrodes thereon.

Another object of the present invention is to provide a high-voltage microchip C⁴D system and method that utilizes improved shielding between electrodes that obviates direct coupling between the actuator electrode and the pick-up electrode, so as to minimize background noise, especially as larger amplitude peak-to-peak voltages are used.

Another object of the present invention is to provide a label-free capillary electrophoresis immunoassay method that saves time and can be practiced in a compact high-voltage microchip C⁴D system because both the immunoassay reaction and the detection of the complexed and free immunoglobulins is performed within the separation channel of a CE microchip.

Another object of the present invention is to provide a high-voltage microchip C⁴D system and method with improved detection limits, as low as 0.5 μM, for small cations and anions.

Another object of the present invention is to provide a high-voltage microchip C⁴D system and method that is practical and cost effective to manufacture and to use.

### SUMMARY OF THE INVENTION

In accordance with the above objectives, the present invention provides, in a first embodiment, a chip-based capillary electrophoresis assembly including: (a) a holder including a frame for removably receiving a chip; (b) a capillary electrophoresis microchip dimensioned to fit onto the holder, and comprising a body and a separation channel defined in the body; and (c) a pair of adhesive detection electrodes integrated with an electronic conductometric detection circuit, wherein the assembly is assemblable by disposing the capillary electrophoresis microchip on the holder and removably placing the adhesive electrodes on the microchip body near the separation channel.

In accordance with a second embodiment of the present invention, the first embodiment is modified so the holder further includes a Faradaic shield disposed on the frame between the electrodes when the capillary electrophoresis microchip is disposed on the frame and the electrodes are placed on the microchip body. In accordance with a third embodiment of the present invention, the second embodiment is modified so the holder further includes a clamp attachable to the microchip body, wherein the clamp serves to hold the capillary electrophoresis chip on the holder when the assembly is fully assembled. In accordance with a fourth embodiment of the present invention, the first embodiment is modified so the adhesive detection electrodes are self-adhesive tape electrodes applied to the holder so when the microchip is assembled on the holder, the detection electrodes are on an undersurface of the microchip. In accordance with a fifth embodiment of the invention, the first embodiment is modified so the electronic conductometric detection circuit further comprises an ac function generator connected to, and amplified by, an amplifier, wherein the electronic conductometric detection circuit applies a peak-to-peak actuation voltage amplitude of about 250-500 V to one of the detection electrodes. In accordance with a sixth embodiment of the invention, the fifth embodiment is modified so the separation channel has a semicircular cross-section width of about 50 μm, and the ac function generator amplified by the amplifier provides a peak-to-peak voltage of about 500 V at a frequency of about 50 kHz. In accordance with a seventh embodiment of the invention, the fifth embodiment is modified so the electronic conductometric detection circuit further comprises a current-to-voltage converter connected to the other one of the detection electrodes and a rectification, low-pass filtering, and offset circuit connected to the current-to-voltage converter. In accordance with an eighth embodiment of the present invention, the first embodiment is modified so the holder further includes a recess defined in the frame for removably receiving the microchip, wherein the recess is defined by a recessed floor in the frame of the holder, and the recess is dimensioned to receive the microchip, and the pair of detection electrodes are disposed on the recessed floor so that when the microchip is assembled in the recess of the holder frame, the electrodes are disposed to cross under the separation channel.

In accordance with a ninth embodiment of the invention, a chip-based capillary electrophoresis assembly is provided that includes: (a) a holder including a frame for removably receiving a chip; (b) a capillary electrophoresis microchip dimensioned to fit onto the holder, and comprising a body, a separation channel defined in the body, and a pair of grooves formed in an outer surface of the body, wherein the grooves are disposed to cross over the separation channel; and (c) a pair of adhesive detection electrodes integrated with an electronic conductometric detection circuit, wherein the assembly is assemblable by disposing the capillary electrophoresis microchip on the holder and removably placing the adhesive electrodes on the microchip body in the grooves near the separation channel. In accordance with a tenth embodiment of the invention, the ninth embodiment is modified so each groove has a floor, and when the assembly is fully assembled one of the adhesive electrodes coheres to the floor of each groove.

In accordance with an eleventh embodiment of the invention, a chip-based capillary electrophoresis assembly is provided that includes: (a) a holder including a frame for removably receiving a chip; (b) a capillary electrophoresis microchip dimensioned to fit onto the holder, and comprising a body, a separation channel defined in the body, and a plurality of grooves formed on the surface of the body; (c) an electronic conductometric detection circuit; and (d) a detection electrode disposed in each groove, wherein each electrode is connected to the electronic conductometric detection circuit, and wherein the assembly is assemblable by disposing the capillary electrophoresis microchip on the holder. In accordance with a twelfth embodiment of the invention, the eleventh embodiment is modified so each detection electrode is an adhesive electrode integrated with the electronic conductometric circuit and the assembly is assemblable by removably placing each detection electrode into one of the grooves on the microchip body. In accordance with a thirteenth embodiment of the invention, the eleventh embodiment is modified so each groove has a floor and each electrode comprises conductive paint painted on the floor of one of the grooves.

In accordance with a fourteenth embodiment of the present invention, an electrodeless capillary electrophoresis microchip is provided that includes: (a) a body; and (b) a separation channel formed in the body. In accordance with a fifteenth embodiment of the present invention, the fourteenth embodiment is modified to further include an injection cross formed in the body so as to be contiguous with the separation channel, and at least one well formed in the body so as to be contiguous with the injection cross. In accordance with a sixteenth embodiment of the present invention, the fourteenth embodiment is modified to further include a first groove formed in a surface of the microchip so as to cross the separation channel and dimensioned so as to receive a removable actuator electrode. In accordance with a seventeenth embodiment of the present invention, the sixteenth embodiment is modified to further include a second groove formed in a surface of the microchip so as to cross the separation channel and dimensioned so as to receive a removable pick-up electrode, wherein the first groove and the second groove are separated by a gap and are arranged anti-parallel to the separation channel. In accordance with an eighteenth embodiment of the present invention, the seventeenth embodiment is modified so the microchip is made of a material selected from the group consisting of glass and a synthetic polymer. In accordance with a nineteenth embodiment of the invention, the eighteenth embodiment is modified so the microchip is made of the synthetic polymer, and the polymer is polymethylmethacrylate.

In accordance with a twentieth embodiment of the invention, a capillary electrophoresis microchip is provided that consists of: (a) a body; (b) a separation channel formed in the body; (c) an injection cross formed in the body and contiguous with the separation channel; (d) a plurality of sample reservoirs connected to the injection cross; (e) a run buffer reservoir connected to the injection cross; and (f) an outlet reservoir connected to the separation channel. In accordance with a twenty-first embodiment of the invention, the twentieth embodiment is modified so the body is made of a material selected from the group consisting of glass and a synthetic polymer. In accordance with a twenty-second embodiment of the present invention, the twenty-first embodiment is modified so the separation channel has either a semicircular, circular or rectangular cross section.

In accordance with a twenty-third embodiment of the invention, a micromachined capillary electrophoresis microchip is provided that includes: (a) a body; (b) a separation channel formed in the body; (c) one or more grooves formed in a surface of the body, wherein each groove is arranged so as to cross over the separation channel; and (d) an electrode formed on a surface of each groove. In accordance with a twenty-fourth embodiment of the present invention, the twenty-third embodiment is modified so each formed electrode is painted on the surface of the corresponding groove with conductive paint. In accordance with a twenty-fifth embodiment of the present invention, the twenty-fourth embodiment is modified so the conductive paint is a conductive silver paint. In accordance with a twenty-sixth embodiment of the present invention, the twenty-fifth embodiment is modified so each groove is formed in the body so as to cross over and above the separation channel, and each groove is orthogonal to the separation channel. In accordance with a twenty-seventh embodiment of the present invention, the twenty-sixth embodiment is modified so each groove has a floor, and the floor of each grove is located approximately 0.2 mm from the separation channel.

In accordance with a twenty-eighth embodiment of the present invention, a method of label-free analyte conductometric detection is provided that includes the steps of: (a) assembling a chip-based capillary electrophoresis assembly, the assembly comprising: (i) a holder including a frame for removably receiving a chip; (ii) a capillary electrophoresis microchip dimensioned to fit onto the holder, and comprising a body and a separation channel defined in the body; and (iii) a pair of adhesive detection electrodes integrated with an electronic conductometric detection circuit, wherein the assembly is assemblable by disposing the capillary electrophoresis microchip on the holder and removably placing the adhesive electrodes on the microchip body so as to cross above or below the separation channel; (b) injecting a sample containing an analyte into the separation channel; (c) applying a separation potential between a pair of separation electrodes, wherein one of the pair of separation electrodes is disposed at each end of the separation channel, so that the analyte migrates along the separation channel; (d) using a function generator integrated in the electronic conductometric detection circuit to apply a high voltage detection potential across the adhesive detection electrodes; and (e) using the electronic conductometric detection circuit to detect the analyte when the analyte migrates by the detection electrodes.

In accordance with a twenty-ninth embodiment of the present invention, the twenty-eighth embodiment is modified so the high voltage detection potential applied across the detection electrodes is an ac voltage having a peak-to-peak amplitude of between about 250-500 V and a frequency of between about 50-100 kHz. In accordance with a thirtieth embodiment of the present invention, the twenty-ninth embodiment is modified so the separation potential applied is a dc voltage having an amplitude of about 3-4 kV. In accordance with a thirty-first embodiment of the present invention, the thirtieth embodiment is modified so the injection of the sample containing the analyte includes applying an injection potential between a pair of injection electrodes for a predetermined period of time, wherein the injection potential is a dc voltage having an amplitude of about 1-2 kV. In a thirty-second embodiment in accordance with the present invention, the twenty-eighth embodiment is modified so the body of the microchip further includes a pair of grooves formed in a surface of the body so as to cross over the separation channel, and the chip-based assembly is assembled by placing one of the detection electrodes respectively in each one of the grooves.

In accordance with a thirty-third embodiment of the present invention, a label-free capillary electrophoresis immunoassay method is provided that includes the steps of: (a) providing a capillary electrophoresis microchip comprising a body and a separation channel defined in the body, and providing a pair of detection electrodes connected to an electronic conductometric detection circuit so the detection electrodes are placed on the microchip body so as to cross above or below the separation channel; (b) injecting a first sample containing a first immunoglobulin into the separation channel; (c) injecting a second sample containing a second immunoglobulin into the separation channel so the second immunoglobulin mixes with the first immunoglobulin; and (d) reacting the first immunoglobulin with the second immunoglobulin within the separation channel to form an immunoglobulin complex.

In accordance with a thirty-fourth embodiment of the present invention, the thirty-third embodiment is modified so the first sample is injected into the separation channel using a first dc voltage applied for a predetermined period of time. In accordance with a thirty-fifth embodiment of the present invention, the thirty-fourth embodiment is modified so the second sample is injected into the separation channel using a second dc voltage applied for a predetermined period of time. In accordance with a thirty-sixth embodiment of the present invention, the thirty-third embodiment is modified to further include pre-conditioning the separation channel with a basic solution followed by rinsing of the separation channel with a run buffer before injecting either the first sample or the second sample into the separation channel. In accordance with a thirty-seventh embodiment of the present invention, the thirty-third embodiment is modified to further include the step of applying a separation potential between a pair of separation electrodes, wherein one of the separation electrodes is disposed at each end of the separation channel so the immunoglobulin complex migrates along the separation channel. In accordance with a thirty-eighth embodiment of the present invention, the thirty-seventh embodiment is modified so the separation potential applied is a dc voltage. In accordance with a thirty-ninth embodiment of the present invention, the thirty-seventh embodiment is modified to further include the step of applying a detection potential across the detection electrodes, wherein the detection potential is an ac voltage having a predetermined peak-to-peak amplitude and a predetermined frequency. In accordance with a fortieth embodiment of the present invention, the thirty-ninth embodiment is modified so the detection potential has a peak-to-peak amplitude of 400 V and a frequency of 50 kHz. In accordance with a forty-first embodiment of the present invention, the thirty-ninth embodiment is modified to further include the step of using the electronic conductometric detection circuit to detect the immunoglobulin complex as the complex migrates by the detection electrodes. In accordance with a forty-second embodiment of the present invention, the thirty-third embodiment is modified so the body of the microchip further includes a pair of grooves formed in a surface of the body so as to cross the separation channel, and the detection electrodes are adhesive electrodes, so when the detection electrodes are placed on the microchip body the electrodes are placed to detachably cohere to a floor of each respective groove. In accordance with a forty-third embodiment of the invention, the thirty-third embodiment is modified so the microchip body is made of glass and the first sample and the second sample each include a run buffer and a surfactant to decrease adherence of the immunoglobulin complex to a wall in the body forming the separation channel. In accordance with a forty-fourth embodiment of the present invention, the forty-third embodiment is modified so the run buffer has a pH greater than an isoelectric point of the first immunoglobulin and an isoelectric point of the second immunoglobulin so as to decrease adherence of each immunoglobulin to the wall in the body forming the separation channel. In accordance with a forty-fifth embodiment, the forty-first embodiment is modified so the time period between forming the immunoglobulin complex in the separation channel and detecting the immunoglobulin complex using the detection circuit is less than one minute. In accordance with a forty-sixth embodiment, the thirty-third embodiment is modified so the first immunoglobulin is IgM and the second immunoglobulin is IgG.

In accordance with a forty-seventh embodiment of the present invention, a capillary electrophoresis assembly is provided that includes: (a) a holder including a frame for removably receiving a chip; (b) a capillary electrophoresis microchip dimensioned to fit onto the holder, and comprising a body and a separation channel defined in the body; and (c) a pair of detection electrodes integrated with an electronic conductometric detection circuit, wherein the detection electrodes are permanently affixed to the holder, wherein the assembly is assemblable by disposing the capillary electrophoresis microchip on the holder so the detection electrodes are disposed on the microchip body near the separation channel. In accordance with a forty-eighth embodiment of the present invention, the forty-seventh embodiment is modified so the detection electrodes are affixed to the holder so when the microchip is assembled on the holder, the detection electrodes are disposed on an undersurface of the microchip. In accordance with a forty-ninth embodiment of the present invention, the forty-seventh embodiment is modified so the holder further comprises an electrode support member attachable to the microchip body, and the detection electrodes are permanently affixed to the electrode support member so when the microchip is assembled on the holder, the electrode support member attaches to the microchip body and the detection electrodes are disposed on a top surface of the microchip.

### BRIEF DESCRIPTION OF THE DRAWINGS

FIG. 1 schematically illustrates a perspective view of the assembled chip-based capillary electrophoresis system in accordance with an embodiment of the present invention.

FIG. 2 shows a perspective view the holder component of the assembled system shown in FIG. 1.

FIG. 3 shows a plan view of the CE microchip component of the assembled system shown in FIG. 1.

FIG. 4 provides a cross sectional view through line A-A of the CE microchip shown in FIG. 3.

FIG. 5 schematically illustrates the electronic conductometric detection circuit component of the system shown in FIG. 1.

FIG. 6 is a schematic plan view of a holder having detection electrodes disposed on a surface (i.e., floor) of the holder.

FIG. 7 is a schematic cross sectional view along the longitudinal B-B axis of the holder shown in FIG. 6 with an “electrodeless” CE microchip in place.

FIG. 8 includes electropherograms of ammonium and magnesium at 200 μM for CE microchips with and without troughs or grooves for placement of detection electrodes: (A) detection electrodes placed on a microchip without grooves at 1 mm distance from separation channel, and (B) detection electrodes placed in electrode grooves on a microchip at 0.2 mm from the separation channel in accordance with the present invention.

FIG. 9 illustrates the effect of applied frequency on the detector response to 200 μM lithium analyte at 250 Vₚ₋ₚ, 300 Vₚ₋ₚ, and at 500 Vₚ₋ₚ using a C⁴D system in accordance with the present invention. The insert shows two electropherograms at 200 μM corresponding to actuator voltages of (A) 250 Vₚ₋ₚ and (B) 500 Vₚ₋ₚ recorded at 100 kHz frequency.

FIG. 10 illustrates the effect of increasing separation voltages on analyte detection voltage peaks for potassium, sodium and magnesium for separation voltages of (a) 2 kV, (b) 3 kV, and (c) 4 kV by using a C⁴D system in accordance with the present invention.

FIG. 11 is an electropherogram of heavy metal ions separated in less than 20 seconds using a C⁴D system in accordance with the present invention.

FIG. 12 is an electropherogram of (1) sodium, (2) lactate and (3) citrate using a C⁴D system in accordance with the present invention.

FIG. 13 is an electropherogram illustrating the separation of (2) 4-acetamidophenol, (3) ibuprofen, and (4) salicylic acid relative to (1) sodium by using a C⁴D system in accordance with the present invention.

FIG. 14 shows electropherograms corresponding to a C⁴D system in accordance with the present invention wherein the CE microchip is made of PMMA and the detection electrodes are adhesive copper tape strips, wherein: (a) is an electropherogram of alkali metal ions at 10 μM, (b) is an electropherogram of heavy metal ions at 50 μM, (c) is an electropherogram of inorganic anions at 50 μM, (d) is an electropherogram of organic acids at 50 μM, and (e) an is electropherogram of amino acids at 100 μM.

FIG. 15 shows electropherograms of Human IgM corresponding to analysis using a C⁴D system in accordance with the present invention wherein the CE microchip is made of PMMA and the detection electrodes are adhesive copper tape strips, wherein: (a) is an electropherogram of IgM at 100 ng/mL, and (b) is an electropherogram corresponding to an IgM-IgG immunoassay.

FIG. 16 is an electropherogram corresponding to a label-free CE immunoassay performed using a C⁴D system in accordance with the present invention wherein the CE microchip is made of glass and the detection electrodes are adhesive copper tape strips adhering to the floor of grooves formed in the surface of the glass CE microchip.

FIG. 17 is a schematic plan view of a prior art CE microchip.

FIG. 18 is a sketch of a prior art contactless electronic detector circuit.

FIG. 19 is a schematic cross sectional view of another “electrodeless” CE microchip embodiment in accordance with the present invention wherein the detection electrodes are disposed on a movable support arm or clamp.

### DETAILED DESCRIPTION OF ILLUSTRATIVE EMBODIMENTS

The present invention includes both a system and method for performing conductometric detection of a wide range of small and large cations and anions by utilizing high-voltage conductivity technology. In particular, the present invention is able to perform conductometric detection of organic acids, amino acids, pharmaceutical molecules, and immunoglobulins in addition to small cations and anions such as alkali and alkaline earth metals and halogens. To facilitate an easy understanding of the features of the present invention, the illustrative apparatus embodiments will be explained first followed by a discussion of the illustrative method embodiments. Lastly, a label-free CE immunoassay method in accordance with the present invention is described. The illustrative embodiments will be described with reference to the drawings in which like parts are labeled with like character references.

The Microchip C⁴D System

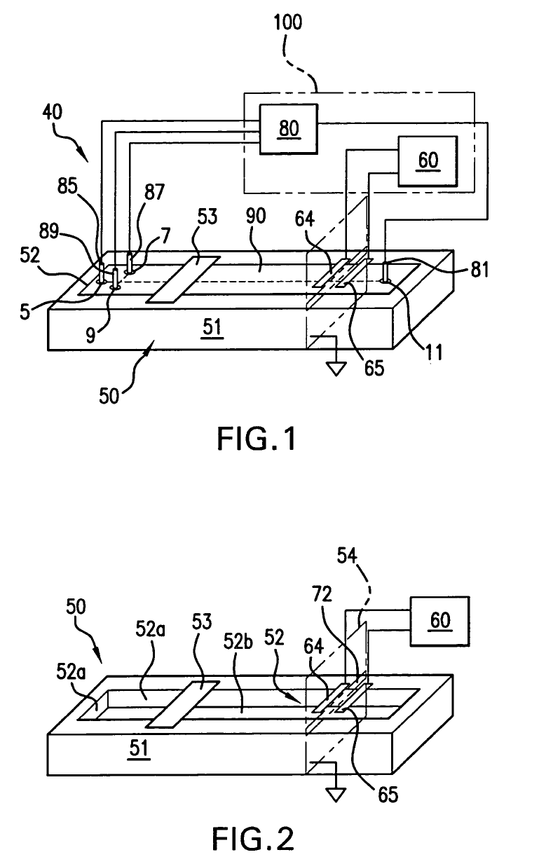

The microchip capacitively coupled contactless conductivity detection (C⁴D) system 40 utilizing high-voltage contactless conductivity (HV-CCD) in accordance with one embodiment of the present invention is a lab-on-chip assembly schematically illustrated in FIG. 1. The microchip C⁴D system 40 includes (a) a holder 50 that incorporates, or is connected to, a pair of electrodes 64, 65, wherein a recess is optionally formed in the body of the holder, (b) an electronic system 100 that includes electronic analytic detection circuit 60 and electronic separation circuit 80 wherein circuit 60 is integrated with the electrodes 64, 65, and (c) a capillary electrophoresis micromachined microchip 90. Circuits 60 and 80 may be separate and distinct components of electronic system 100 or they may be integrated together as a single unit. The C⁴D system 40 may be referred to as a micromachined capillary electrophoresis assembly or as a microfluidic device, which are chip-based capillary electrophoresis apparatuses.

It is important to note that chip-based electrokinetic separation systems, such as C⁴D system 40, are distinguished from C⁴D in capillary electrophoresis systems, which utilize a capillary tube to provide a separation channel (for example, see Tanyanyiwa et al. 2002, Analyst, 127, 214-218). This distinguishing characteristic between chip-based C⁴D systems, which incorporate the electrophoresis separation channel in a microchip, and C⁴D in capillary systems, which utilize a capillary tube to provide the electrophoresis separation channel, is an art recognized distinguishing feature between these devices (Zemann 2003, Electrophoresis, 24, pp. 2125-2137).

The Holder

Microchip holder 50 is shown separately in FIG. 2 and includes a frame 51 with an optional recess 52 defined in the frame for removably receiving the microchip 90. When frame 51 is constructed without recess 52, frame 51 includes a flat, planar surface on which the microchip 90 can rest. Frame 51 is made of a non-conducting durable material, such as PMMA plastic or plexi-glass, and preferably includes walls 52a and floor 52b that define the recess 52. However, the holder 50 of the present invention can be made, with suitable modifications as described above, without recess 52. The holder 50 has a clamp 53 that attaches to the frame 51. Clamp 53 serves to hold the microchip 90 on the holder 50, and preferably in recess 52, when the various components of the system 40 are assembled. While the geometry of the recess 52 is not critical, it is important that the recess 52 and the microchip 90 be proportionately dimensioned so that the microchip fits into the recess when the system 40 utilizes the recess 52.

Holder 50 also includes a pair of detection electrodes 64, 65, which are integrated with the electronic analytic subsystem 60, and a Faraday shield 54. The electrodes 64, 65 are preferably copper foil, although other suitably conductive and malleable metals can be used. In one embodiment in accordance with the present invention, at least one portion of each detection electrode 64, 65 is securely fixed and permanently mounted to the non-conductive frame 51 and another portion of each detection electrode is positionable on an outer surface of the microchip 90. Thus, the positionable portion of each electrode 64, 65 can be pressed against the outer surface of the microchip 90. In an alternative embodiment of the invention, the detection electrodes 64, 65 are connected only to the electronic detection circuit 60 and not fixed directly to the holder 50. In this alternative embodiment, the detection electrodes 64, 65 are reversibly placeable directly on the microchip 90 so as to adhere to the outer surface of the microchip without the use of permanent glues. To achieve the desired positionable feature of the electrodes, each electrode 64, 65 is preferably a strip of adhesive copper tape having a thickness of about 50 μm, a width of about 0.5-2 mm, and a length of about 5 mm. However, those skilled in the art would realize that other electrode geometries could be used. Only one side of the adhesive copper tape is provided with adhesive. The detection electrodes 64, 65 are arranged so as to be parallel to one another and to be anti-parallel to the longitudinal axis A-A of the separation channel formed in the microchip 90 when the system 40 is fully assembled. Preferably, a gap 72 of about 1.0-2.5 mm separates the actuator electrode 64 from the pick-up electrode 65 when these electrodes are properly placed.

Holder 50 is also provided with a Faraday shield 54 disposed in the gap 72 between the electrodes 64, 65. The Faraday shield 54 is necessary because, if the shield is omitted, significant direct coupling between the actuator electrode 64 and the pick-up electrode 65 would occur, thereby causing an undesirably high background signal and significant deterioration of the signal-to-noise (S/N) ratio. Additional Faradaic shielding (not shown) is also provided to completely encompass the C⁴D system 40 when assembled and in use.

Capillary Electrophoresis Microchips

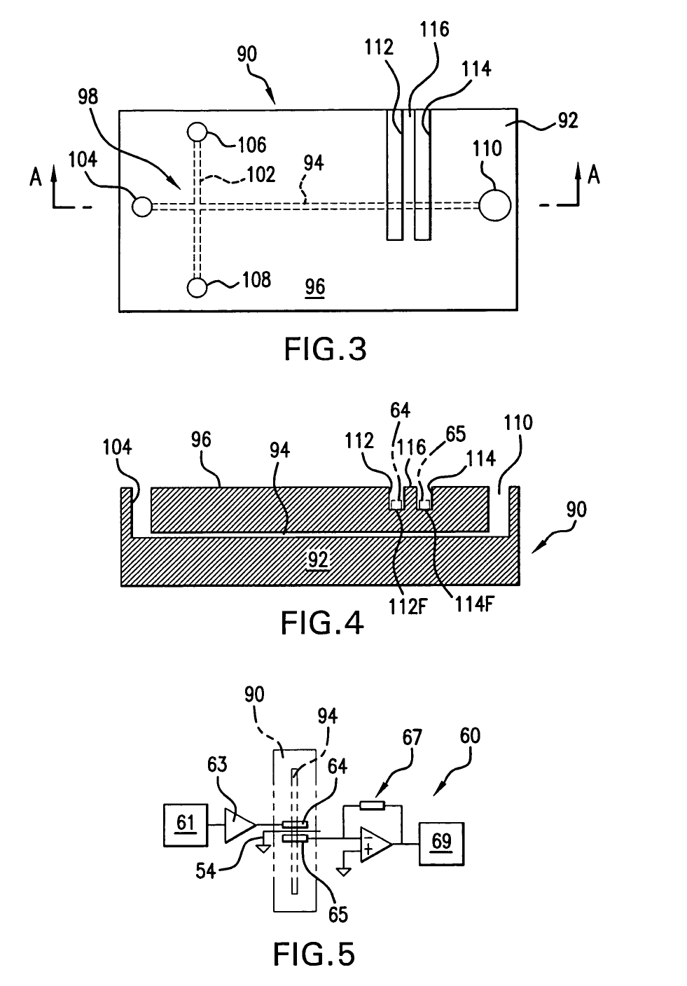

The capillary electrophoresis (CE) microchips 90 used in the present invention can be commercially available glass microchips or can be fabricated from polymethylmethacrylate (PMMA). Other suitable polymers and other materials can also be used. When a recess 52 is provided, the microchips 90 and the optional recess 52 of the holder frame 51 must be dimensioned so that the microchips fit properly into the recess. Each microchip 90, as shown in FIGS. 3 and 4, is provided with a separation channel 94 formed in the body 92 of the microchip along the longitudinal axis A-A. Typically, the separation channel is 80-85 mm in length and is located at a depth of about 50 μm to 1 mm beneath the upper surface 96. The separation channel 94 may have a semicircular, rectangular or circular cross section, and typically has a maximum width of about 50 μm. Although microchip 90 has been illustrated with one separation channel 94, it is within the scope of the present invention to have more than one separation channel per microchip.

Each CE microchip 90 includes an injection cross 98 formed by the intersection of the separation channel 94 with a shorter channel 102 of identical cross-section dimensions. The injection cross 98 and the separation channel 94 are contiguous with a run buffer reservoir 104, a first sample reservoir 106, and a second reservoir 108. These reservoirs 104, 106, 108 are dimensioned to receive a hypodermic needle that can be used to inject a buffer or a sample into the injection cross and separation channel, and to receive conductive electrodes, such as shown in FIG. 1 and as will be discussed later. The separation channel 94 terminates at outlet reservoir 110.

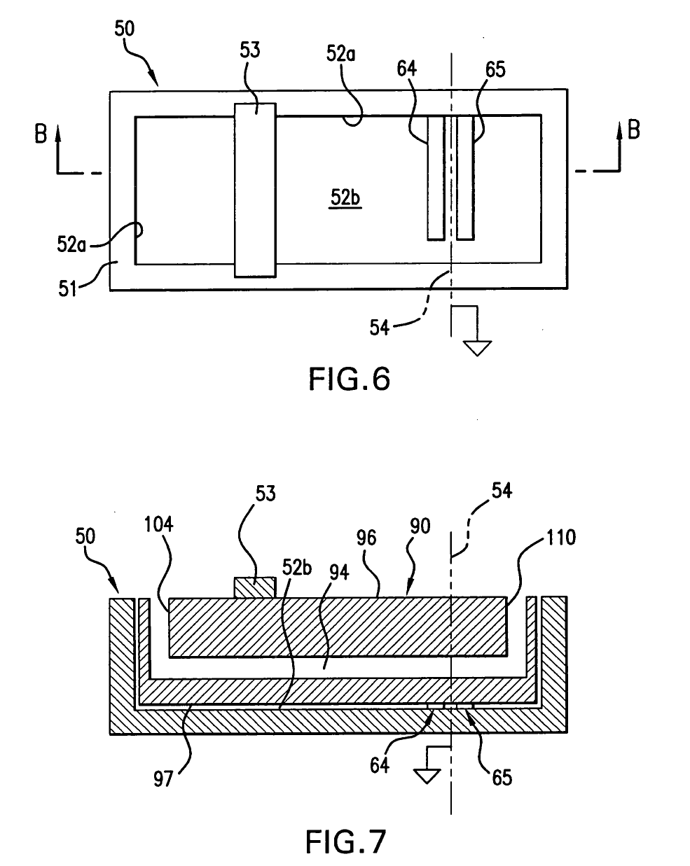

An important feature of certain embodiments of the present invention is that the microchips 90 do not include the actuator electrode 64 and the pick-up electrode 65 of the electronic analytic circuit 60. In other words, such microchips 90, as shown in FIGS. 3 and 4, are constructed so as to exclude these detection electrodes from the manufacture of the chips. Instead, the actuator electrode 64 and the pick-up electrode 65 are constructed to be disposed on, and/or constitute components of, the holder 50 as shown in FIGS. 6 and 7. This feature of the holder 50 allows for the manufacture of “electrodeless” CE microchips 90, which simplifies manufacture of these disposable chips and decreases the overall cost to make and use the C⁴D system 40. Those skilled in the art would appreciate that while the holder 50 is reusable, use of the C⁴D system 40 will require frequent replacement of microchips 90. Therefore, any simplification to the structure and manufacture of the microchips will have a significant impact on lowering the total cost of operating the system as a whole.

To minimize the distance between the detection electrodes 64, 65 and the separation channel 94, the CE microchip 90 is preferably provided with a pair of grooves 112, 114 formed on the upper surface 96. (For the purpose of this disclosure, the term “groove” is synonymous and interchangeable with trough. The term “well” denotes a hole or cavity in which fluid is stored or contained, such as a reservoir). In this embodiment of the microchips 90, the grooves 112, 114 are arranged so as to be anti-parallel (i.e., orthogonal) to the separation channel 94 and dimensioned to cross over and above the separation channel. In addition, the grooves 112 and 114 are dimensioned to receive one of electrodes 64, 65, respectively. A gap 116 separates the grooves 112, 114. The gap 116 is dimensioned to correspond to the width of gap 72 between the detection electrodes. When the microchip 90 is assembled with holder 50, the electrodes 64 and 65 are respectively disposed in one of the grooves 112 and 114. It is important to note though that not all embodiments of the microchip 90, in accordance with the present invention, will include the grooves 112, 114.

Preferably, when the embodiment of system 40 utilizes grooves 112, 114 and adhesive tape electrodes, the adhesive side (i.e., the sticky side) of electrodes 64 and 65 are used to cohere to the floor 112f or 114f of the respective recess 112 or 114. In the context of this application, the word “cohere” is synonymous with the word “adhere,” and these terms are limited to non-permanent bonds such as provided by a sticky surface that clings or holds itself in place without hardening or curing. This definition of the words “cohere” and “adhere” exclude permanent bonding such as is provided by glues, paints and similar materials that harden or cure to form a more or less permanent bond.

Thus, in a preferred embodiment in accordance with the C⁴D system of the present invention, when the microchip 90 is positioned in the recess 52 of the holder 50, adhesive tape electrodes 64, 65 are arranged in the grooves 112, 114 so as to adhere to the floor of the respective groove as shown in FIG. 1. The grooves 112 and 114 not only make it possible to position the electrodes 64 and 65 closer to the separation channel 94, but the grooves also reliably facilitate the proper positioning of these electrodes relative to the separation channel. Those skilled in the art would realize that the present invention can be practiced without the use of grooves 112 and 114 formed in body 92 of the microchip 90; however, the advantages of having these grooves would be lost. Without the presence of the grooves 112, 114, the adhesive electrodes 64, 65 are placed directly on the surface of the body 92, and there is a greater risk that the electrodes 64, 65 will not be properly positioned on the microchip 90.

The Electronic System

The electronic system 100 that drives the present invention includes the contactless electronic analytic detection circuit 60 and the electronic separation circuit 80, which can be constructed as a single integrated circuit or which can be maintained as separately distinct units. The separation circuit 80 serves to provide the direct current (dc) voltages used to inject and separate out the ions in the separation channel 94 and the analytic circuit 60 serves to provide the alternating current (ac) voltages used to perform the detection of various ions.

The separation circuit 80 includes two high-voltage power supplies that are controlled by a built-in interface connected to a multifunctional I/O-card located in a standard personal computer. The power supply used for injection is connected by wires to injection electrodes 87 and 89, which are placed in reservoirs 7 and 9, respectively, as shown in FIG. 1. To inject sample analytes into the injection cross 98, the injection power supply must be able to provide a direct voltage of around 1 kV for 2-3 seconds with a polarity selectable depending upon the sample analyte polarity (i.e., positive voltage polarity selected for positive analytes and negative voltage polarity selected for negative analytes). The power supply used for separation is connected by wires to separation electrodes 85 and 81, which are placed in reservoirs 5 and 11, respectively, as shown in FIG. 1. To separate sample analytes in the separation channel 94, the separation power supply must be able to provide a direct voltage of around 3-4 kV for up to 50 seconds or more. Voltage polarity provided by the separation power supply must be appropriately selectable depending upon the polarity of the sample analytes (i.e., (+) polarity for (+) analytes and (−) polarity for (−) analytes).

The analytic circuit 60 is diagrammed in FIG. 5 and is a contactless electronic conductometric detection circuit. A sinusoidal frequency function generator 61 provides the ac voltage signal that is used for analyte detection. Frequency generator 61 is connected to booster amplifier 63, which boosts the signal amplitude and is connected to the actuator electrode 64. The pick-up electrode 65 is connected to a current-to-voltage converter 67, which is connected to a circuit 69 for rectifying, filtering and offsetting the voltage signal provided by the converter 67. In this manner, the signal provided by the pick-up electrode 65 is converted to a voltage that is rectified, filtered and offset before utilization as an analyte detection signal. Preferably, the frequency generator 61 provides a selectable frequency signal of about 10 kHz to 1 MHz and a peak-to-peak voltage amplitude of up to 20 V. The booster amplifier 63 is a variable amplifier that can be selectively adjusted to provide peak-to-peak voltage amplitudes of around 20-500 V by amplifying the voltage generated by the frequency generator 61. For the purposes of this specification, electrodes 64 and 65 may be referred to as “detection electrodes” to distinguish them from electrodes used in the separation circuit 80 for injection and separation of analytes.

Alternate Embodiment of the Microchip C⁴D System

The microchip C⁴D system 40 can be practiced using various modifications without departing from the spirit and scope of the present invention. FIGS. 6 and 7 illustrate one such alternate embodiment in accordance with the present invention. In FIG. 6, microchip holder 50 has been constructed so that the detection electrodes 64 and 65 are disposed on the floor 52b defining the recess 52. When the holder 50 is constructed without recess 52, the detection electrodes 64, 65 are simply placed on a flat surface portion of the holder. In these embodiments, the CE microchip 90 has no grooves for receiving the electrodes. The detection electrodes 64, 65 in this case can still be practiced as thin adhesive electrodes, which are about 50 μm thick, and the clamp 53 can be used to provide a downward force against upper surface 96 to press the microchip 90 down onto the electrodes 64, 65 as shown in FIG. 7. In the alternative, the detection electrodes 64, 65 can be formed using conductive paint, such as conductive silver paint or other equivalent, patterned on the recess floor 52b, or on the flat surface portion, of the holder 50.

It is reemphasized that, in accordance with certain embodiments of the present invention, the detection electrodes 64, 65 are attached to, or integrated with, electronic system 100 of the holder 50 so that the microchips 90 remain electrodeless. In this embodiment of the present invention, the detection electrodes 64, 65 are preferably permanently fixed and mounted to the holder 50. When the system 40 is assembled with the microchip 90 on the holder 50, the clamp 53 pushes the underneath surface 97 of the microchip 90 against detection electrodes 64, 65. In this embodiment, the detection electrodes are mounted to the holder 40 so as to be disposed on the underneath surface 97 of the microchip 90 and near the separation channel 94 when the system 40 is assembled. Besides using adhesive electrodes or conductive paint, the detection electrodes can also be printed on the holder 40 using other technologies known in the art. An important advantage of these embodiments is that the detection electrodes 64, 65 are not glued or adhered directly to the microchip 90 in any way.

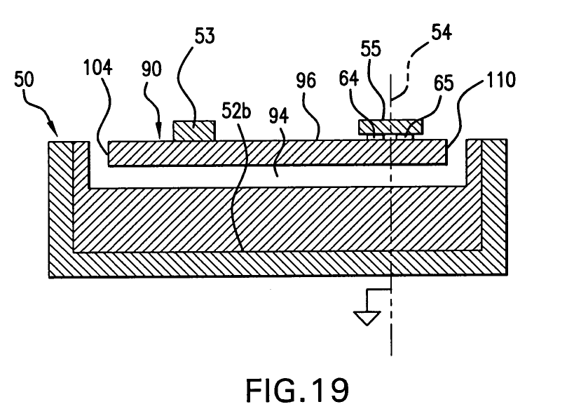

FIG. 19 illustrates another alternate embodiment of the microchip C⁴D system 40 in accordance with the present invention. In FIG. 19, microchip holder 50 has been constructed to include a second clamp 55, or other support arm member, that removably attaches to the frame 51, or other portion of the holder 50. The support arm member 55 is positionable so as to press against the microchip 90 when the system 40 is assembled. In this embodiment, detection electrodes 64, 65 are preferably permanently fixed and mounted to the support arm member 55 so that when the microchip 90 is assembled on the holder 50 the support arm member 55 is disposed to press the detection electrodes against the upper or top surface 96 microchip. As shown in FIG. 19, when system 40 is assembled, the detection electrodes 64, 65 are positioned so as to be disposed on the microchip body and near the separation channel 94. Those skilled in the art would realize that the detection electrodes 64, 65 could be provided using adhesive copper tape; however, it is preferable to glue copper foil to the support arm member 55, or to print the detection electrodes onto the support arm member 55 using a conductive paint, or to use some other printing technology known in the art to form the detection electrodes on the support member. An important advantage of this embodiment of the present invention is that the detection electrodes are mounted to the support arm 55, and they are not glued or adhered directly to the microchip 90 in any way.

Operation of the Microchip C⁴D System

In operation, the microchip C⁴D system 40 is assembled in stages so that the CE microchip 90 is properly positioned in the recess 52 of holder 50 as shown in FIG. 1. First, the microchip 90 is placed in the holder 50. Second, the clamp 53 is engaged to hold the microchip 90 in place so as to prevent movement or shifting of the microchip in the recess while analyte detection is in process. Third, the adhesive detection electrodes 64, 65 are arranged and positioned so as to removably adhere to the upper surface 96 of the microchip, or to the flat floor of the holder 50. The arrangement and positioning of the detection electrodes 64, 65 is performed carefully so that the electrodes are near the separation channel 95 and disposed so as to be anti-parallel to the longitudinal axis A-A of the separation channel. In addition, the detection electrodes 64 and 65 are preferably placed so that the Faraday shield 54 is positioned between these two electrodes. Preferably, when the microchip 90 is provided with a pair of grooves 112, 114 for receiving the detection electrodes, each detection electrode is disposed in one of the grooves to ensure a more reliable and consistent detection electrode placement. In this case, the adhesive surface of each detection electrode 64, 65 is arranged so as to adhere to the floor of the respective groove 112, 114, and the geometry of the grooves ensures that the Faraday shield 54 is arranged between these two electrodes. When grooves for detection electrode placement are utilized, the grooves will permit placement of the detection electrodes 64, 65 closer to the separation channel 94, which results in greater analyte detection sensitivity for the C⁴D system 40.

Once the microchip 90 has been secured in the holder 50 by engaging the clamp 53, and the detection electrodes 64, 65 properly applied to the microchip, the channels in the microchip must be primed with buffer and the sample reservoir loaded with a sample analyte solution. First, the run buffer reservoir 104 is injected with a suitable run buffer using a hypodermic needle, or a pipette tip, until the injection cross 98, the separation channel 94, and the reservoirs 106, 108, 110 are suitably filled with run buffer. Suitability of a run buffer is dependent upon the nature of the selected analyte so a comprehensive listing of run buffers will not be provided. However, for example, a 1:1 morpholinoethansulfonic (MES)/histidine (His) buffer at its natural pH may be used for analyzing alkaline earth analytes, inorganic anions, and organic acids. 18-Crown-6 is included in the MES/His buffer for resolution of rubidium and potassium during cation analysis. For heavy metal analytes, a histidine, α-hydroxyisobutyruic acid (HIBA) buffer at pH 4.5 may be employed. For analysis of amino acids, a 10 mM 3-(cyclohexylamino)-1-propansulfonic acid (CAPS)/50 mM 2-amino-2-methyl-1-propanolol (AMP) buffer at pH of 10.8 may be used. However, the present invention is not limited to any particular analyte and buffer combination. Those skilled in the art of capillary electrophoresis would realize that the present invention is practiced using a run buffer that is most suitable for the particular analyte(s) selected for detection.

Once the microchip 90 is primed with run buffer, the sample solution containing the analyte(s) of interest is injected or loaded into the first sample reservoir 106 using a hypodermic needle or pipette tip. Next, the separation circuit 80 is connected and secured to the microchip 90 as follows. Injection electrodes 87, 89 and separation electrodes 85, 81 are positioned and secured in reservoirs 7, 9, 5, 11 respectively so as to be in contact with the buffer solution therein. These injection and separation electrodes can be secured in place using non-conductive tape or non-conductive clamps, or by using any other suitable means for securing.

At this point, the microchip C⁴D system 40 in accordance with the present invention had been completely assembled, primed and loaded, and the electrophoresis detection run is ready to be performed. To perform the electrophoresis run, first an injection potential is applied across the injection electrodes 87 and 89 at about 1 kV for 2-3 seconds to inject an analyte “plug” through the injection cross 98 and into the separation channel 94. After the injection electrodes are de-energized, a separation potential of about 3-4 kV is applied across the separation electrodes 85 and 81 for the duration of the electrophoresis run. As mentioned previously, the polarity (i.e., positive or negative) of the injection potential and the separation potential depends upon the polarity of the sample analytes. In other words, a positive polarity is generally applied when analyzing positive analytes and a negative polarity is generally applied when analyzing negative analytes.

Conductometric analyte analysis is performed by applying an actuation potential across the detection electrodes 64, 65 while the separation potential forces the analyte sample to migrate along the separation channel 94. These potentials are applied roughly orthogonally to the separation channel in accordance with the orthogonal positioning of the detection electrodes 64, 65 to the separation channel 94. The actuation potential is an ac voltage with an amplitude of about 250-500 Vₚ₋ₚ and a frequency of about 50-100 kHz. Application of the actuation potential across the detection electrodes 64, 65 results in the formation, as various analytes pass between the detection electrodes, of distinctive analyte detection signals, which are picked-up by pick-up electrode 65, and subsequently converted from current to voltage, rectified, filtered and offset by the remainder of the electronic analytic circuit 60 to generate output analyte detection voltage signals. The output analyte detection voltage signals can be used to generate electropherograms, and/or can be stored in the memory of a personal computer, (e.g., such as the computer integrated in the separation circuit 80), and/or the analyte detection output signals can be further processed by a microprocessor (e.g., such as provided by the personal computer integrated in the separation circuit 80) connected to the analytic circuit 60.

Using the general electrophoretic method described above, the microchip C⁴D system 40 in accordance with the present invention can be assembled and operated to perform conductometric analysis of analyte samples. Having described the general apparatus and method embodiments in accordance with the present invention, several non-limiting illustrative examples will be described to highlight the superiority of the present invention over prior art electrophoresis devices and methods.

### FIRST EXAMPLE

### The Affect of Grooves on the CE Microchip

The first example highlights the affect of having the detection electrodes mounted in grooves on the surface of the microchip 90. The microchips used in this first example are commercially available glass microchips (model MC-BF4-TT100, Micralyne, Edmonton, Canada) containing a standard injection cross. The separation channel is 85 μm long with a semicircular cross section of 50 μm width and 20 μm depth buried approximately 1 mm below the upper surface of the microchip. Grooves for placement of the detection electrodes were made in the upper surface of the microchips either by ultrasonic abrasion, with an imprinting tool, or manually using a cutting wheel attached to a high frequency spindle. In either case, the floor of each groove was situated approximately 0.2 mm from the separation channel, and the detection electrodes were formed on the floor of each groove using conductive silver paint. Each detection electrode was approximately 0.5 mm wide and 5 mm long with a gap of 1 mm separating the actuator and pick-up electrodes.

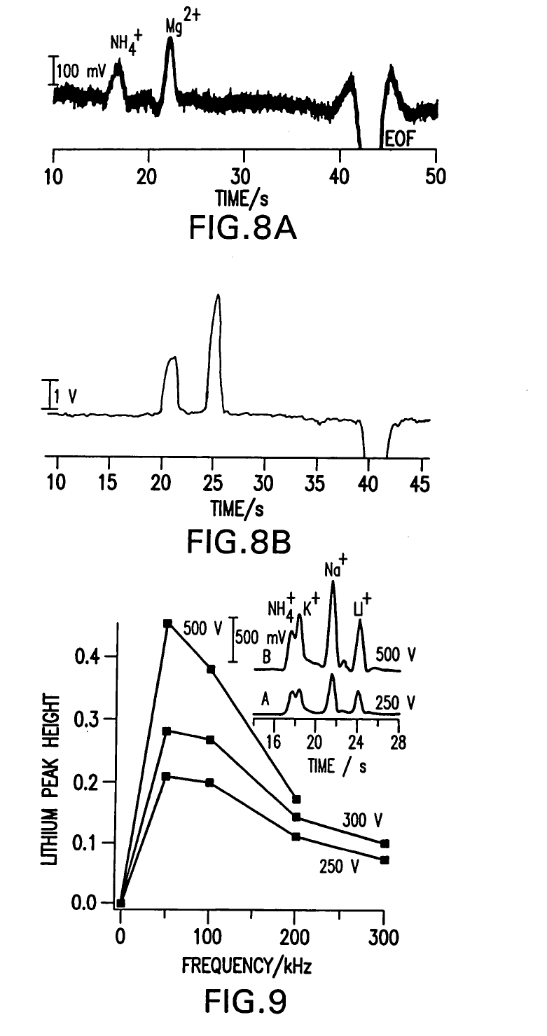

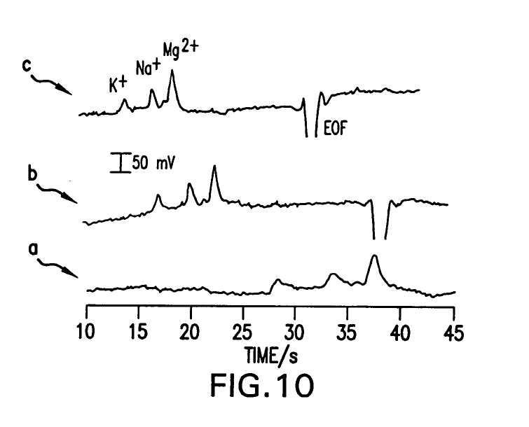

FIG. 8 demonstrates the unexpectedly superior detection sensitivity obtained using a glass CE microchip having detection electrodes disposed in grooves versus a CE microchip having detection electrodes painted on the surface of the microchip without grooves. In this run, the analyte sample solution included ammonium and magnesium cations at 200 μM in buffer of 10 mM MES/His with 2 mM 18-Crown-6 at a pH of 6. The injection potential was +1 kV for 2 seconds and the separation potential was +3 kV. The actuator voltage was 500 Vₚ₋ₚ at a frequency of 100 kHz.

Electropherogram (A) of FIG. 8 demonstrates ammonium and magnesium analyte detection voltages of about 100-200 mV when the detection electrodes are painted on the surface of an unaltered CE microchip (i.e., no grooves formed on the microchip surface for detection electrode placement), so the detection electrodes are located about 1 mm from the separation channel. Electropherogram (B) demonstrates ammonium and magnesium analyte detection voltages of about 2-4 V when the CE microchip is provided with grooves in which the detection electrodes are placed so the detection electrodes are located 0.2 mm from the separation channel. While those skilled in the art of microchip electrophoresis would expect some improvement in detection voltage amplitude as a result of locating the detection electrodes closer to the separation channel, the observed 20-fold improvement in analyte detection voltage was not foreseeable in view of moving the detection electrodes closer in electropherogram (B) to ⅕^{th} the distance from the separation channel that was tested in electropherogram (A). Thus, the use of grooves for the placement of detection electrodes produced a superior and unexpected result.

In electropherograms (A) and (B) of FIG. 8, those skilled in the art will recognize that a portion of these curves is attributed to electroosmotic flow (abbreviated, “EOF”). Electroosmotic flow (EOF) arises in electrophoresis when ions are separated using their differential mobility in an electric field because, on any surface in water, there is a charge separation between stationary ions on the surface of the water and counterions in the liquid. The electroosmotic flow is the bulk flow, or net flow, of the liquid itself superimposed on the electrophoretic movement of the ions of interest. On glass microchips, there are silanol groups that create a very well defined system of surface ions, which has the benefit that the EOF is stable and fairly well reproducible. Thus, eletropherograms created using glass microchips will tend to have a fairly reproducible EOF portion. However, when other materials are used, such as PMMA or other polymers, to make the CE microchip, there may not be intrinsic surface chemical groups that can dissociate into immobile and mobile ions. In these cases, an EOF peak may still be observed presumably due to a non-specific weak adsorption of ionic species located around the surface of the polymer material. Thus, in the case of polymer CE microchips EOF peaks will be less well defined and may not be stable or reproducible over time.

### SECOND EXAMPLE

### The Effect of Applied Frequency to Detector Response

The second example highlights the effect of applied voltage and frequency on the peak height of analyte detection voltage amplitude. Glass CE microchips having detection electrodes placed in grooves were used for this experiment. In this run, 200 μM of lithium analyte in 10 mM MES/his buffer with 2 mM 18-Crown-6 at pH 6 was analyzed using an injection potential of +0.5 kV for 3 seconds and a separation potential of +3 kV. Actuation voltage potentials of 250 Vₚ₋ₚ, 300 Vₚ₋ₚ, and 500 Vₚ₋ₚ were studied at 50, 100, 200 and 300 kHz.

As shown in FIG. 9, the optimal lithium analyte detection voltage (i.e., highest detection sensitivity) was observed for the combination of 500 Vₚ₋ₚ actuation potential at a frequency of 50 kHz. It is noted that a more stable baseline was observed for the combination of 500 Vₚ₋ₚ at a frequency of 100 kHz. Thus, optimum analyte detection is a function of both the peak-to-peak voltage amplitude and the frequency of the actuation signal. The insert in FIG. 9 shows two electropherograms (A) and (B) of ammonium, potassium, magnesium and lithium corresponding to actuator voltages of 250 Vₚ₋ₚ and 500 Vₚ₋ₚ, respectively, performed under the same conditions and in the same buffers as used to analyze lithium only.

### THIRD EXAMPLE

### Effect of the Separation Voltage on Detection Peaks

The third example highlights the effect of varying the separation voltage on the analyte detection voltage peaks. Glass CE microchips having detection electrodes placed in grooves were used for this experiment. In this run, potassium, sodium and magnesium at 20 μM in 10 mM MES/his buffer were analyzed using an injection potential of +0.5 kV for 3 seconds and an actuation voltage of 500 Vₚ₋ₚ at 100 kHz. Separation voltages were increased incrementally from (a)+2 kV, (b)+3 kV, and then to (c)+4 kV.

At +2 kV, the potassium peak had a migration time of 28 seconds, and all peaks were severely broadened. Increasing the separation voltage lead to shorter migration times, sharper peaks, and better detection limits. Using the +4 kV separation potential and repeating the experiment produced detection limits of 0.49, 0.41, and 0.35 μM for potassium, sodium and magnesium respectively. These observed detection limits for potassium and sodium are better than about ⅓ to ½ the detection limits of 1.2 and 2.0 μM, respectively, achieved by Wang's prior art system (Anal. Chem. 2002, 74, p. 1971).

### FOURTH EXAMPLE

### Separation of Heavy Metal Ions

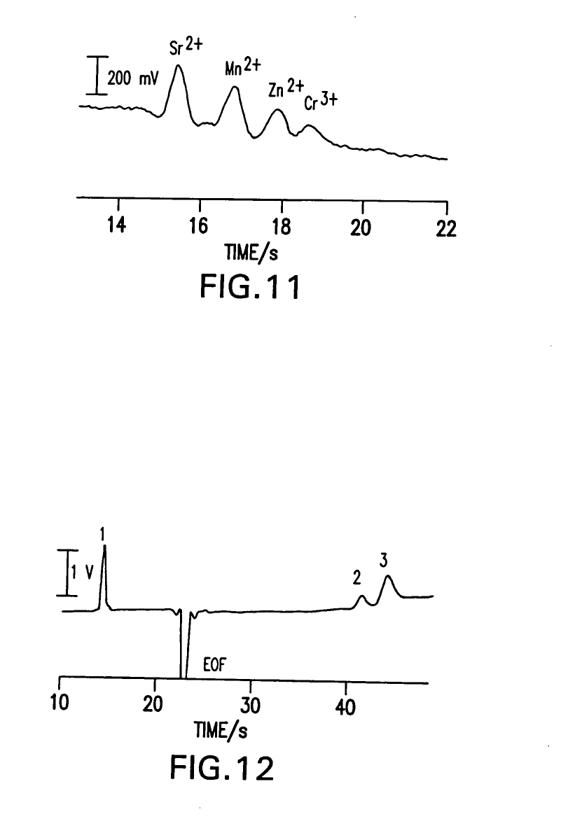

The fourth example demonstrates that a C⁴D system in accordance with the present invention can separate and analyze heavy metal ions with improved sensitivity. Glass CE microchips having detection electrodes placed in grooves were used for this experiment. Strontium, manganese, zinc and chromium ions at 50 μM in a 5 mM his, 3 mM HIBA buffer at pH 4.5 were separated, as shown in FIG. 11, using a separation potential of +5 kV and an actuation potential of 500 Vₚ₋ₚ at 100 kHz. The injection potential was +500 V for 3 seconds. The detection limits estimated from the data in FIG. 11 are 1.4, 2.1, 2.8 and 6.8 μM respectively for strontium, manganese, zinc and chromium, which is better than the detection limits obtained with a MES/HIS-HIBA buffer on conventional capillaries.

### FIFTH EXAMPLE

### Separation of Low Mobility Anions

The fifth example demonstrates that a C⁴D system in accordance with the present invention can separate and analyze low mobility anions with improved sensitivity. Glass CE microchips having detection electrodes placed in grooves were used for this experiment. Low mobility anions, lactate and citrate, were separated using a 10 mM CHES/6 mM Arg electrolyte solution at natural pH of 9. The concentrations of the lactate and citrate sodium salts in buffer was 100 μM. An injection potential of 500 V for 3 seconds was used, followed by a separation potential of 5 kV and an actuation voltage of 500 Vₚ₋ₚ at 100 kHz frequency.

The electropherogram corresponding to the fifth example is shown in FIG. 12, wherein peak (1) corresponds to sodium, peak (2) corresponds to lactate, and peak (3) corresponds to citrate. The 3×S/N (“signal-to-noise ratio of 3”) detection limits for lactate and citrate are 5.5 and 2.3 μM, respectively, for a C⁴D system in accordance with the present invention.

### SIXTH EXAMPLE

### Separation of Pharmaceutically Related Compounds

The sixth example shows that a C⁴D system in accordance with the present invention can separate and analyze pharmaceutically relevant compounds with improved sensitivity. Glass CE microchips having detection electrodes placed in grooves were used for this experiment. Pharmaceutically relevant compounds 4-acetamidophenol, ibuprofen and salicylic acid at 100 μM were separated using a 10 mM CAPS/Arg buffer at pH 10. An injection potential of 500 V for 3 seconds was used, followed by a separation potential of 5 kV and an actuation voltage of 500 Vₚ₋ₚ at 100 kHz frequency.

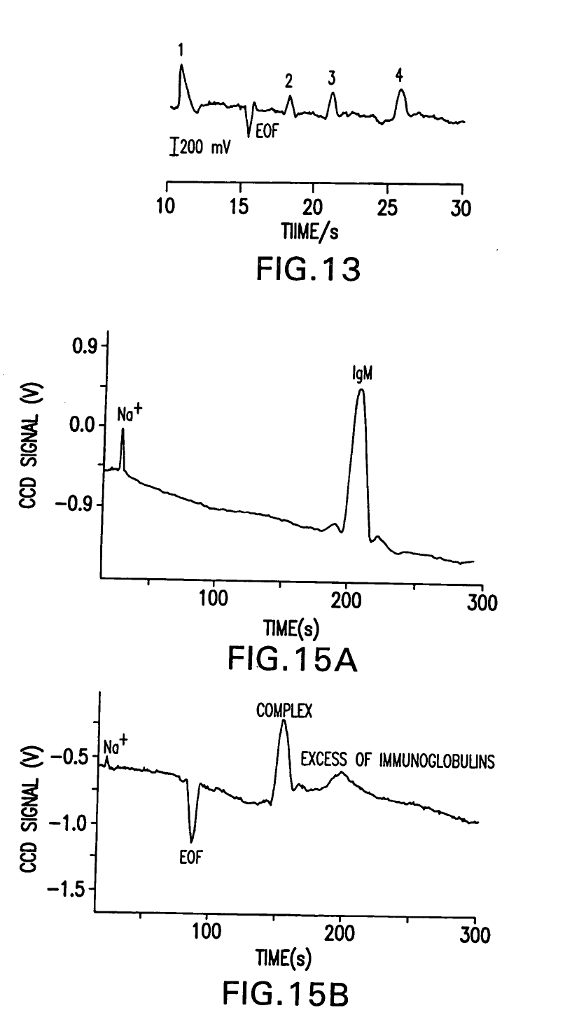

4-Acetamidophenol and ibuprofen are anti-inflammatory agents with analgesic and anti-pyretic properties. Acetylation of salicylic acid yields acetylsalicylic acid, which is another widely used drug for reducing inflammation, pain and fever. Pharmaceutical preparations of ibuprofen and 4-acetamidophenol are commercially available. FIG. 13 is a electropherogram of these three compounds, which are all anions at the pH of 10. The analyte peaks in FIG. 13 illustrate a direct response; therefore, the electrolyte possesses a background conductivity lower than that of the analytes. Estimated detection limits for these three species, 4-acetamidophenol, ibuprofen, and salicylic acid, are all approximately 10 μM.

### SEVENTH EXAMPLE

### PMMA CE Microchips

The seventh example demonstrates the advantages of a C⁴D system in accordance with the present invention wherein the CE microchips are made of poly(methylmethacrylate), (abbreviated “PMMA”) and the detection electrodes are strips of adhesive copper tape, which detachably cohere to the surface of the CE microchip. In this example, each PMMA CE microchip is constructed from a plate about 1 mm thick, which contains a longitudinal separation channel of about 50 μm depth, width of about 50 μm, and length of about 80 mm with access holes (i.e., wells) to the surface at each end of the channel. The injection cross is formed by intersection of the separation channel with a shorter channel of identical cross section. The channel is sealed underneath with a thin PMMA foil that is 100 μm thick. The microchips were fabricated via hot embossing with a steel master followed by sealing of the microchannel with the foil by application of heat and pressure. Microchannels of good surface quality and reliable sealing without leaks are thus obtained. Each PMMA CE microchip is constructed without detection electrodes integrally formed therewith.

When in use, a PMMA CE microchip is placed on a holder, also made of PMMA. Then, two copper adhesive detection electrodes made from adhesive copper tape are positioned approximately 1 cm from the channel end. Each detection electrode is about 50 μm thick and 2 mm wide. These two detection electrodes are placed on the PMMA CE microchip so as to cohere to its surface and separated by a gap of 2.5 mm. A Faraday shield is employed between the two detection electrodes. The C⁴D system in accordance with the seventh example utilizes an actuation potential with a peak-to-peak amplitude of 500 V and a frequency of 100 kHz.

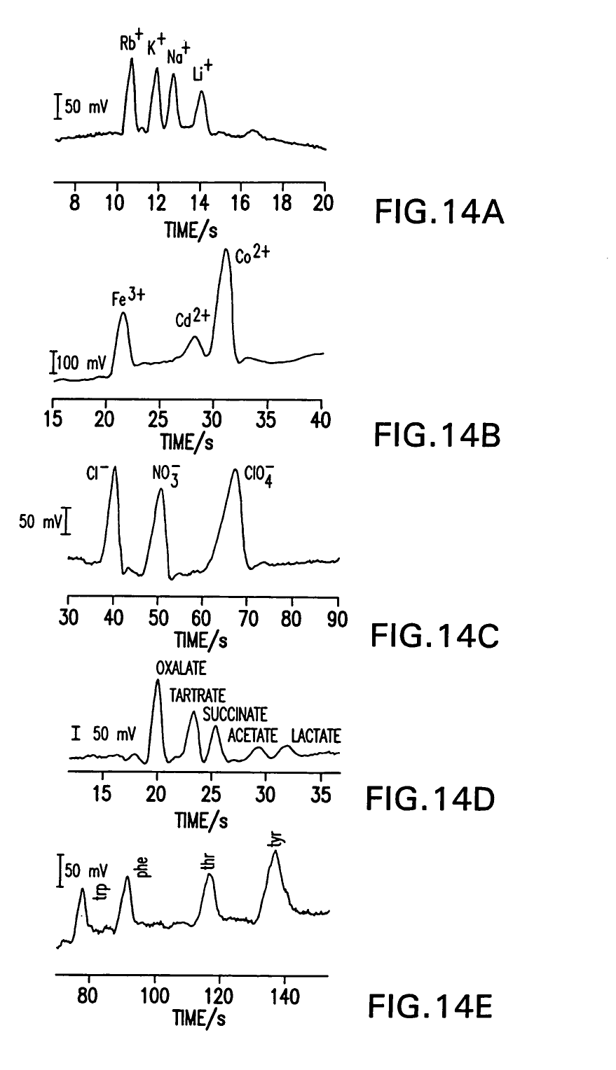

FIG. 14(a) illustrates the electropherogram for alkali metal ions rubidium, potassium, sodium and lithium at 10 μM, and separated using the PMMA CE microchip of the seventh example. The run buffer used was 10 mM MES/His buffer with 4 mM 18-Crown-6 at pH of 6.0. The injection potential was +1 kV for 3 seconds, followed by a separation voltage of +3 kV and the actuation potential of 500 Vₚ₋ₚ at frequency 100 kHz. Based on the peak heights shown in the electropherogram of FIG. 14(a) and a signal-to-noise ration of 3 (i.e., 3×S/N), the lower limits of detection for these small alkali metal ions is 1.5 μM.

FIG. 14(b) illustrates the electropherogram for heavy metal ions iron, cadmium and cobalt at 50 μM, and separated using the PMMA CE microchip of the seventh example. The run buffer used was 5 mM His, 3 mM HIBA at pH of 4.5. The injection potential was +1 kV for 3 seconds, followed by a separation voltage of +3 kV and the actuation potential of 500 Vₚ₋ₚ at frequency 100 kHz. Based on the peak heights shown in the electropherogram of FIG. 14(b) and a signal-to-noise ration of 3 (i.e., 3×S/N), the lower limits of detection for the heavy metal ions Fe³⁺, Cd²⁺, and Co²⁺was determined to be 3.5, 8 and 2 μM, respectively

FIG. 14(c) illustrates the electropherogram for inorganic anions Cl⁻, NO₃⁻ and ClO₄⁻ at 50 μM, and separated using the PMMA CE microchip of the seventh example. The run buffer used was 10 mM MES/His buffer. The injection potential was −1 kV for 3 seconds, followed by a separation voltage of −4 kV and the actuation potential of 500 Vₚ₋ₚ at frequency 100 kHz. Based on the peak heights shown in the electropherogram of FIG. 14(c) and a signal-to-noise ration of 3 (i.e., 3×S/N), the lower limits of detection for these inorganic anions Cl⁻, NO₃⁻ and ClO₄⁻ was determined to be 2.5. 3 and 2.5 μM, respectively.

FIG. 14(d) illustrates the electropherogram for organic anion species oxalate, tartate, succinate, acetate and lactate at 50 μM, and separated using the PMMA CE microchip of the seventh example. The run buffer used was 10 mM MES/His buffer containing 200 μM CTAB. The injection potential was −1 kV for 3 seconds, followed by a separation voltage of −3 kV and the actuation potential of 500 Vₚ₋ₚ at frequency 100 kHz. Based on the peak heights shown in the electropherogram of FIG. 14(d) and a signal-to-noise ration of 3 (i.e., 3×S/N), the lower limits of detection for the organic anions oxalate, tartate, succinate, acetate and lactate was determined to be 4.4, 7, 10, 25 and 30 μM, respectively.

FIG. 14(e) illustrates the electropherogram for amino acid species tryptophan, phenylalanine, threonine and tyrosine at 100 μM under basic conditions, and separated using the PMMA CE microchip of the seventh example. The run buffer used was 10 mM CAPS/50 mM AMP at pH of 10.8. Due to the zwitterionic nature of amino acids, which are cations at acidic pH values and anions at basic pH values, electrophoresis can be performed either under acidic or basic conditions. In this case, the basic condition was adopted. The injection potential was +1 kV for 3 seconds, followed by a separation voltage of −4 kV and the actuation potential of 500 Vₚ₋ₚ at frequency 100 kHz. Based on the peak heights shown in the electropherogram of FIG. 14(e) and a signal-to-noise ration of 3 (i.e., 3×S/N), the lower limits of detection for the amino acids tryptophan, phenylalanine, threonine and tyrosine were found to be 50, 43, 45 and 32 μM, respectively.

### EIGHTH EXAMPLE

### Application of PMMA CE Microchips to IgM Detection and Immunoassay

In the eighth example, a C⁴D system in accordance with the present invention comprising a PMMA CE microchip and detachable self-adhesive copper tape detection electrodes is utilized to detect immunoglobulin, such as IgM, and to perform a label-free immunoassay. In the context of the description of the present invention, a “label-free immunoassay” will be defined as an immunoassay that does not use a labeled reagent for fluorescence or electrochemical detection. It is also noted that the C⁴D system described in this example is a HV-CCD system that performs a HV-CDD method.

In this example, the PMMA CE microchip was a commercially available chip from the Microfluidic Chip Shop (Jena, Germany) and contained a manifold in the double cross configuration. The separation channel was 8 cm long. Hypodermic needles were used to introduce the buffer and solutions to be analyzed into the reservoirs of the microchip. When the PMMA CE microchip was placed on the holder and secured with a clamp, the two detection electrodes were provided by parallel copper strips 1 mm wide and 5 mm long and detachably cohered to the undersurface of the 175 μm thick bottom cover of the microchip so as to lay across the separation microchannel, such as shown in FIG. 7. The detection electrodes were arranged so as to be separated by a uniform gap of 1 mm.

Here, the following reagents are defined: 2-amino-2-methyl-1,3-propanediol (abbreviated, “AMPD”); N-tris(hydroxymethyl)-methyl-3-aminopropanesulfonic acid (abbreviated, “TAPS”); tris(hydroxymethyl)aminomethane (abbreviated, “Tris”); and polyoxyethylene sorbitan monolaurate, 70% in water (abbreviated, “Tween 20”). The PMMA CE microchip was preconditioned with 0.1 M NaOH before thoroughly rinsing with water and subsequently flushing with buffer. For the direct determination of IgM, aliquots of different concentrations varying from 10 to 500 ng/mL were diluted with 20 mM TAPS/AMPD buffer, pH 8.7 and containing 0.05% Tween 20. Human IgM (purified immunoglobulin, 1 mg/mL, Sigma) was diluted into working aliquots with 20 mM Tris-HCl buffer, pH 7.4 to perform immunological reactions and with the 20 mM TAPS/AMPD buffer, pH 8.7, containing 0.05% Tween 20 when performing conductometric detection in the PMMA CE microchip. The electrokinetic injection of IgM plugs into the separation channel was performed using 1 kV for 3 seconds. Separation was performed using a separation potential of 4 kV. The actuation potential was provided using a sinusoidal function generator boosted by a high voltage application stage in accordance with the detection circuit shown in FIG. 5. In this example, the actuation potential used was 400 Vₚ₋ₚ at frequency 104 kHz. Washing the channels of the microchips between runs ensured reproducibility and maintained a stable baseline.

Human IgM was chosen as the model analyte because it possesses certain important significance from a clinical point of view. It predominates in the early phases of primary viral infections and in some persistent viral infections. In addition, it is found in high levels at birth and in intrauterine infections, as well as in all phases of HIV infection. IgG (i.e., anti-IgM) is also included in this model. Those skilled in the art would predict that the method and apparatus in accordance with the present invention should be equally applicable to other immunoglobulin types such as IgA and IgE.

Using the PMMA CE microchip and essentially the C⁴D system configuration shown in FIGS. 6 and 7, different concentrations of IgM, ranging from 10 to 500 ng/mL, were analyzed on the microchip. The data collected from these runs was used to obtain the following linear relationship:
Peak area(V.S.)=0.15[IgM]+3.07 (I)
where the peak area is in volts times seconds (“V.S.”) and [IgM] is the concentration of IgM in ng/mL. This linear relationship for the peak area had a correlation coefficient of r=0.998 when each concentration was analyzed three times (i.e., n=3). Using the calibration curve provided by equation I, the limits of IgM detection was calculated as the concentration corresponding to three times the standard deviation of the intercept. In this way the detection limits of a micromachined C⁴D system detecting IgM, using a PMMA CE microchip and C⁴D system configuration as in FIGS. 6 and 7, was 34 ng/mL.

FIG. 15(a) is the electropherogram showing the detection peak of human IgM at 100 ng/mL. The sodium peak is present because the IgM was preserved in sodium azide. A comparison was made to the HV-CCD analysis of IgM using the PMMA CE chip and a HV-CCD analysis method for IgM using a fused silica capillary having a 50/m internal diameter and 50 cm length. The HV-CCD method utilizing a silica capillary utilized a run buffer of TAPS/AMPD containing 0.01% Tween 20, an injection potential of 5.7 kV for 5 seconds, a separation potential of 20 kV, and an actuation voltage of 300 Vₚ₋ₚ at frequency 100 kHz.

It was found that while the HV-CCD capillary method and system provided more sensitive detection (i.e., an IgM detection limit of 0.15 ng/mL was calculated), it took much longer. Specifically, the time to detect the IgM peak took about 200 seconds using the PMMA CE microchip whereas it took about 6 minutes to detect the IgM peak using a silica capillary. Thus, a HV-CCD system using a PMMA CE microchip can perform the IgM detection analysis in about half the time it would take a HV-CCD system using a silica capillary. Those skilled in the art would realize that the use of PMMA CE microchips have both the advantage of smaller size and faster detection processing over systems using capillary tubes. These advantages are desired for making portable systems for on-site detection analysis.

The HV-CCD PMMA CE microchip method and system utilized in this eighth example can also be used to perform CE based immunoassays termed capillary electrophoresis immunoassays (abbreviated, “CEIA). In this example, Human IgM is reacted with monoclonal anti-human IgM (IgG fraction of mouse ascites fluid, clone MB-11, 2 mg/mL, Sigma). The first step of the CEIA was carried out in conventional ELISA microliter plates, wherein either human IgM or mouse IgG (i.e., anti-human IgM) was incubated overnight with 200 μL of a 2% solution of bovine serum albumin, fraction V (BSA, Sigma) prepared in 0.1 Tris-HCl buffer, pH 7.4. After washing thoroughly with 0.1 M Tris-HCl buffer, pH 7.4, 100 μL of IgM solution with concentrations ranging from 0.5 to 2 μg/mL was placed in respective wells with 100 μL of IgG at a fixed concentration of 10 μg/mL. The IgM and IgG mixtures were left to react for 15 minutes. After reacting for the prescribed time, 25 μL of the content of each well was diluted up to 1000 μL with 20 mM TAPS/AMPD buffer, pH 8.7, containing 0.05% Tween 20, and then placed in the microchip sample reservoir. Electrokinetic injection was performed at 1 kV for 3 seconds followed by separation by a separation potential of 4 kV. The actuation voltage used was 400 Vₚ₋ₚ at frequency 104 kHz.

FIG. 15(b) is the electropherogram corresponding to the ELISA reaction when the reaction well contained 100 μL of 10 μg/mL IgM and 100 μL of 10 μg/mL IgG, incubated for 15 minutes in the 0.1 M Tris buffer (pH 7.4), then transferred and diluted before placement in the sample well of the PMMA CE microchip. As shown in FIG. 15(b), the peak of the immunoglobulin IgM-IgG complex arrived at the detector in about two minutes and the mixture of free immunoglobulins appeared shortly thereafter. One disadvantage of the PMMA microchip is that the EOF is not very stable because the absorption effects on PMMA devices are difficult to predict. Consequently, there can be a loss of sensitivity when using a CE microchip made of PMMA when compared to microchips and some capillary devices made of glass.

### NINTH EXAMPLE

### Application of Glass CE Microchips to CEIA

In the ninth example, a C⁴D system in accordance with the present invention comprising a glass CE microchip and detachable self-adhesive copper tape detection electrodes disposed in grooves on the microchip is utilized to detect immunoglobulins, such as IgM and IgG, in performance of a label-free immunoassay. It is noted that the C⁴D system described in this example is a HV-CCD system that performs a label-free immunoassay using a HV-CCD method.

In this example, the glass CE microchip was a commercially available chip from Micralyne (Model MC-BF4-TT100, Edmonton, Canada) and contained a manifold having the injection cross configuration. The separation channel was 8 cm long. However, the Micralyne glass CE microchip was modified to have two grooves milled across the top of the separation channel such as described in FIGS. 3 and 4. Each groove had a width of about 1 mm milled by using a cutting wheel on the surface of the microchip. Hypodermic needles were used to introduce the buffer and solutions to be analyzed into the reservoirs of the glass microchip. When the glass CE microchip was placed on the holder and secured with a clamp, the two detection electrodes were provided by parallel copper strips 1 mm wide and 5 mm long and detachably cohered to the floor of the respective groove on the microchip so as to lay across the separation microchannel. The detection electrodes were arranged so as to be separated by a uniform gap of 1 mm.

In this example, the C⁴D system in accordance with the present invention was configured as in FIGS. 1 and 2. In addition, the CEIA was actually performed inside the glass CE microchip instead of externally in microtiter plates. In summary, the method for performing a label-free CEIA in accordance with the present invention involved the following steps.

First, the C⁴D system capable of performing HV-CCD is provided, such as the system shown in FIGS. 1 and 2, wherein the detection electrodes are disposed to cohere to the floor of respective grooves in the glass microchip. This step can be practiced using a glass microchip having the detection electrodes painted to the floor of each groove, or a glass microchip having no grooves. Second, the glass CE microchip having grooves for the detection electrodes, such as shown in FIGS. 3 and 4, is preconditioned with 0.1 M sodium hydroxide before thoroughly rinsing with water and subsequently flushing the microchannels with 20 mM TAPS/AMPD buffer, pH 8.7, containing 0.01% Tween 20. Third, the sample reservoir was filled with a 10 μg/mL solution of human IgM. Fourth, the IgM sample is injected into the injection cross by applying an injection potential, which was 2 kV for 5 seconds in this case. Fifth, the IgM solution is removed from the sample reservoir and replaced by a 10 μg/mL solution of mouse IgG (i.e., anti-human IgM). Sixth, the IgG sample is injected into the injection cross by applying the injection potential, which was 2 kV for 5 seconds.

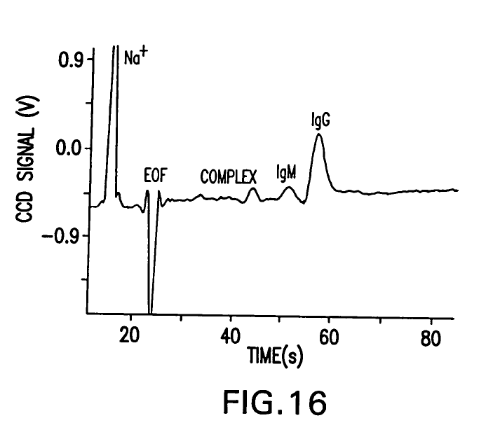

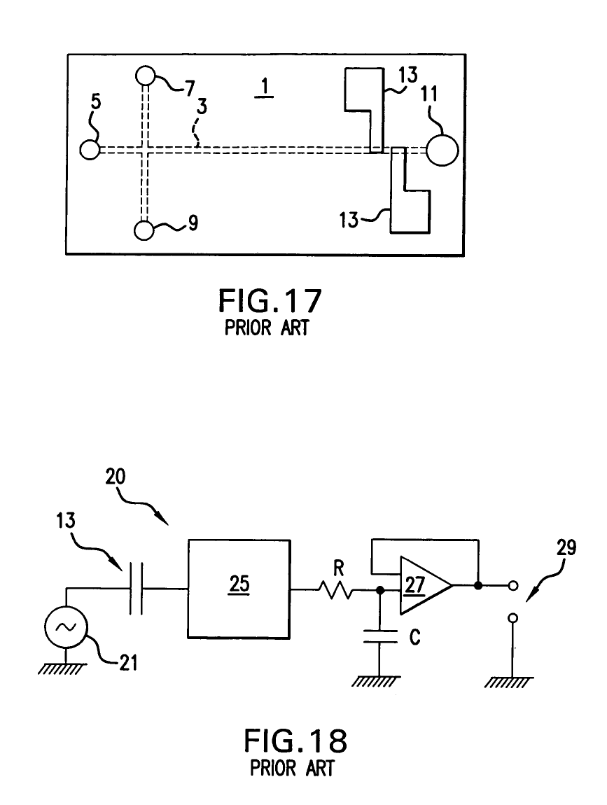

Once the IgG sample is injected into the separation channel, the IgM and IgG begin to mix and to react to form the IgM-IgG immunocomplex. Seventh, separation of the IgM and IgG mixture was achieved by applying a separation voltage, which was 4 kV in this case. During separation, a high voltage actuation potential, in this case 400 Vₚ₋ₚ at frequency 50 kHz, was applied across the copper detection electrodes. Eighth, the electronic system of the C⁴D system generates immunoglobulin/analyte output detection signals, such as can be used by a computer, microprocessor, or other device, so that immunoglobulin detection peaks are identified or detected. In one embodiment, the immunoglobulin output detection signals are used to generate an electropherogram, such as the one shown in FIG. 16. After use, the glass CE microchip is rinsed with water to prevent clogging of the reservoirs and microchannels.

FIG. 16 is an electropherogram corresponding to the label-free CEIA method performed outlined above using an electrodeless glass CE microchip in accordance with one embodiment of the present invention. FIG. 16 shows that the label-free CEIA method of the present invention can clearly and adequately separate out the IgM-IgG complex peak from the free unreacted IgM and IgG peaks. Therefore, the label-free CEIA method of the present invention, performed in the separation channel of the CE microchip itself, provides both an effective method for reacting immunoglobulins in an immunoassay and an effective method for separating and distinguishing peaks for complexed and free immunoglobulins resulting from the immunoassay. As shown in FIG. 16, this analysis can be performed in less than a minute. In other words, the time period between formation of the immunoglobulin complex and the detection of the immunoglobulin complex peak can be performed in less than one minute.

Miscellaneous Considerations

While the CE methods and micromachined C⁴D systems for performing the methods in accordance with the present invention have been adequately described, several additional points deserve mentioning. First, knowledge of the isoelectric point (pI) of the compounds to be examined, whether macromolecules or immunoglobulins for example, is very important in determining optimal conditions for electrophoretic separation. For instance, the pI of human IgM lies between 5.1 and 7.8 and for human IgG the pI lies between 5.8 and 7.3. Therefore, the conditions under which the illustrative examples 1-9 were performed are not limiting. Those skilled in the art would recognize that examining molecules having different isoelectric points may require changes in the pH or the run buffer without departing from the spirit or scope of the present invention.

A run buffer should be chosen with a pH that provides maximum separation without damaging the properties of the sample molecule, especially when working with complex molecules such as immunoglobulins. Tris buffer was employed in the present examples 8 and 9 when analyzing immunoglobulins because Tris buffer has been successfully used before in analyzing IgM. The AMPD buffer is a zwiterionic buffer normally employed for the separation of polypeptides and macromolecules. The natural pH of the 20 mM TAPS/AMPD buffer is 8.7. Thus, this mixture provides a buffer suitable for immunoglobulins because immunoglobulins will have a negative ionic charge at this pH, which leads to less protein adsorption with the walls of the capillary. It is known that wall adsorption of proteins, such as immunoglobulins, constitutes a problem in capillary electrophoresis. This phenomenon retards the migration of the protein molecules and broadens the peak band width, thereby reducing sensitivity. To overcome this problem, a surfactant (i.e., Tween 20) was also added to the buffer. Optionally, the pH of the run buffer could also be increased to above 8, which is a value greater than the pI of the antibodies, so as to minimize the interaction between the immunoglobulins and the capillary surface. Interaction between the capillary surface and the immunoglobulins is minimized at a pH above 8 because both would be negatively charged. Those skilled in the art would realize that other buffers in combination with suitable surfactants and pH values could be used to practice the present invention without departing from the spirit and scope.

The run buffer used in the examples 8 and 9 was also adequate for keeping a low conductivity value. At a 20 kV separation potential, the electric current in a capillary was measured at 8 μA. In these examples, baseline stability was increased by employing a Tris buffer.

The various method and apparatus embodiments in accordance with the present invention show that capillary electrophoresis in a CE microchip employed in a HV-CCD system is an effective and superior way of performing conductometric detection of simple analytes (i.e., alkali metals, heavy metals, etc.), small molecules (i.e., lactate, citrate), pharmaceutically related compounds, immunoglobulins and immunoglobulin complexes. The use of these methods and apparatuses provide a detection system based upon conductometric analysis that allows the development of analyte analysis and direct capillary electrophoresis immunoassays that do not involve labeling molecules. In addition, the conductometric detection in accordance with the present invention enables the concurrent monitoring of all species involved in an immunoreaction when applied to immunoassays.

While the present invention has been described with reference to certain preferred embodiments, one of ordinary skill in the art will recognize that other additions, deletions, substitutions, modifications and improvements can be made while remaining within the spirit and scope of the present invention as defined by the claims.

1. A chip-based capillary electrophoresis assembly comprising:
a holder including a frame for removably receiving a chip;
a capillary electrophoresis microchip dimensioned to fit onto the holder, and comprising a body and a separation channel defined in the body; and
a pair of adhesive detection electrodes integrated with an electronic conductometric detection circuit, wherein the assembly is assemblable by disposing the capillary electrophoresis microchip on the holder and removably placing the adhesive electrodes on the microchip body near the separation channel.

2. A capillary electrophoresis assembly as recited in claim 1, wherein the holder further includes a Faradaic shield disposed on the frame between the electrodes when the capillary electrophoresis microchip is disposed on the frame and the electrodes are placed on the microchip body.

3. A capillary electrophoresis assembly as recited in claim 2, wherein the holder further includes a clamp attachable to the microchip body, wherein the clamp serves to hold the capillary electrophoresis chip on the holder when the assembly is fully assembled.

4. A capillary electrophoresis assembly as recited in claim 1, wherein the adhesive detection electrodes are self-adhesive tape electrodes applied to the holder so when the microchip is assembled on the holder, the detection electrodes are on an undersurface of the microchip.

5. A capillary electrophoresis assembly as recited in claim 1, wherein the electronic conductometric detection circuit further comprises an ac function generator connected to, and amplified by, an amplifier, wherein the electronic conductometric detection circuit applies a peak-to-peak actuation voltage amplitude of about 250-500 V to one of the detection electrodes.

6. A capillary electrophoresis assembly as recited in claim 5, wherein the separation channel has a semicircular cross-section width of about 50 μm, and the ac function generator amplified by the amplifier provides a peak-to-peak voltage of about 500 V at a frequency of about 50 kHz.

7. A capillary electrophoresis assembly as recited in claim 5, wherein the electronic conductometric detection circuit further comprises a current-to-voltage converter connected to the other one of the detection electrodes and a rectification, low-pass filtering, and offset circuit connected to the current-to-voltage converter.

8. A capillary electrophoresis assembly as recited in claim 1, wherein the holder further includes a recess defined in the frame for removably receiving the microchip, wherein the recess is defined by a recessed floor in the frame of the holder, and the recess is dimensioned to receive the microchip, and the pair of detection electrodes are disposed on the recessed floor so that when the microchip is assembled in the recess of the holder frame, the electrodes are disposed to cross under the separation channel.

9. A chip-based capillary electrophoresis assembly comprising:
a holder including a frame for removably receiving a chip;
a capillary electrophoresis microchip dimensioned to fit onto the holder, and comprising a body, a separation channel defined in the body, and a pair of grooves formed in an outer surface of the body, wherein the grooves are disposed to cross over the separation channel; and
a pair of adhesive detection electrodes integrated with an electronic conductometric detection circuit, wherein the assembly is assemblable by disposing the capillary electrophoresis microchip on the holder and removably placing the adhesive electrodes on the microchip body in the grooves near the separation channel.

10. A capillary electrophoresis assembly as recited in claim 9, wherein each groove has a floor, and when the assembly is fully assembled one of the adhesive electrodes coheres to the floor of each groove.

11. A chip-based capillary electrophoresis assembly comprising:
a holder including a frame for removably receiving a chip;
a capillary electrophoresis microchip dimensioned to fit onto the holder, and comprising a body, a separation channel defined in the body, and a plurality of grooves formed on the surface of the body;
an electronic conductometric detection circuit; and
a detection electrode disposed in each groove, wherein each electrode is connected to the electronic conductometric detection circuit, and wherein the assembly is assemblable by disposing the capillary electrophoresis microchip on the holder.

12. A capillary electrophoresis assembly as recited in claim 11, wherein each detection electrode is an adhesive electrode integrated with the electronic conductometric circuit and the assembly is assemblable by removably placing each detection electrode into one of the grooves on the microchip body.

13. A capillary electrophoresis assembly as recited in claim 11, wherein each groove has a floor and each electrode comprises conductive paint painted on the floor of one of the grooves.

14. An electrodeless capillary electrophoresis microchip comprising:
a body; and
a separation channel formed in the body.

15. An electrodeless capillary electrophoresis microchip as recited in claim 14, further comprising: an injection cross formed in the body so as to be contiguous with the separation channel, and at least one well formed in the body so as to be contiguous with the injection cross.

16. An electrodeless capillary electrophoresis microchip as recited in claim 14, further comprising a first groove formed in a surface of the microchip so as to cross the separation channel and dimensioned so as to receive a removable actuator electrode.

17. An electrodeless capillary electrophoresis microchip as recited in claim 16, further comprising a second groove formed in a surface of the microchip so as to cross the separation channel and dimensioned so as to receive a removable pick-up electrode, wherein the first groove and the second groove are separated by a gap and are arranged anti-parallel to the separation channel.

18. An electrodeless capillary electrophoresis microchip as recited in claim 17, wherein the microchip is made of a material selected from the group consisting of glass and a synthetic polymer.

19. An electrodeless capillary electrophoresis microchip as recited in claim 18, wherein the microchip is made of the synthetic polymer, and the polymer is polymethylmethacrylate.

20. A capillary electrophoresis microchip consisting of:
a body;
a separation channel formed in the body;
an injection cross formed in the body and contiguous with the separation channel;
a plurality of sample reservoirs connected to the injection cross;
a run buffer reservoir connected to the injection cross; and
an outlet reservoir connected to the separation channel.

21. A capillary electrophoresis microchip as recited in claim 20, wherein the body is made of a material selected from the group consisting of glass and a synthetic polymer.

22. A capillary electrophoresis microchip as recited in claim 21, wherein the separation channel has either a semicircular, circular or rectangular cross section.

23. A micromachined capillary electrophoresis microchip comprising:
a body;
a separation channel formed in the body;
one or more grooves formed in a surface of the body, wherein each groove is arranged so as to cross over the separation channel; and
an electrode formed on a surface of each groove.

24. A micromachined capillary electrophoresis microchip as recited in claim 23, wherein each formed electrode is painted on the surface of the corresponding groove with conductive paint.

25. A micromachined capillary electrophoresis microchip as recited in claim 24, wherein the conductive paint is a conductive silver paint.

26. A micromachined capillary electrophoresis microchip as recited in claim 25, wherein each groove is formed in the body so as to cross over and above the separation channel, and each groove is orthogonal to the separation channel.

27. A micromachined capillary electrophoresis microchip as recited in claim 26, wherein each groove has a floor, and the floor of each grove is located approximately 0.2 mm from the separation channel.

28. A method of label-free analyte conductometric detection comprising the steps of:
(a) assembling a chip-based capillary electrophoresis assembly, the assembly comprising:
(i) a holder including a frame for removably receiving a chip;
(ii) a capillary electrophoresis microchip dimensioned to fit onto the holder, and comprising a body and a separation channel defined in the body; and
(iii) a pair of adhesive detection electrodes integrated with an electronic conductometric detection circuit, wherein the assembly is assemblable by disposing the capillary electrophoresis microchip on the holder and removably placing the adhesive electrodes on the microchip body so as to cross above or below the separation channel;
(b) injecting a sample containing an analyte into the separation channel;
(c) applying a separation potential between a pair of separation electrodes, wherein one of the pair of separation electrodes is disposed at each end of the separation channel, so that the analyte migrates along the separation channel;
(d) using a function generator integrated in the electronic conductometric detection circuit to apply a high voltage detection potential across the adhesive detection electrodes; and
(e) using the electronic conductometric detection circuit to detect the analyte when the analyte migrates by the detection electrodes.

29. A method as recited in claim 28, wherein the high voltage detection potential applied across the detection electrodes is an ac voltage having a peak-to-peak amplitude of between about 250-500 V and a frequency of between about 50-100 kHz.

30. A method as recited in claim 29, wherein the separation potential applied is a dc voltage having an amplitude of about 3-4 kV.

31. A method as recited in claim 30, wherein the injection of the sample containing the analyte includes applying an injection potential between a pair of injection electrodes for a predetermined period of time, wherein the injection potential is a dc voltage having an amplitude of about 1-2 kV.

32. A method as recited in claim 28, wherein the body of the microchip further includes a pair of grooves formed in a surface of the body so as to cross over the separation channel, and the chip-based assembly is assembled by placing one of the detection electrodes respectively in each one of the grooves.

33. A label-free capillary electrophoresis immunoassay method comprising the steps of:
(a) providing a capillary electrophoresis microchip comprising a body and a separation channel defined in the body, and providing a pair of detection electrodes connected to an electronic conductometric detection circuit so the detection electrodes are placed on the microchip body so as to cross above or below the separation channel;
(b) injecting a first sample containing a first immunoglobulin into the separation channel;
(c) injecting a second sample containing a second immunoglobulin into the separation channel so the second immunoglobulin mixes with the first immunoglobulin; and
(d) reacting the first immunoglobulin with the second immunoglobulin within the separation channel to form an immunoglobulin complex.

34. A method as recited in claim 33, wherein the first sample is injected into the separation channel using a first dc voltage applied for a predetermined period of time.

35. A method as recited in claim 34, wherein the second sample is injected into the separation channel using a second dc voltage applied for a predetermined period of time.

36. A method as recited in claim 33, further comprising pre-conditioning the separation channel with a basic solution followed by rinsing of the separation channel with a run buffer before injecting either the first sample or the second sample into the separation channel.

37. A method as recited in claim 33, further comprising the step of applying a separation potential between a pair of separation electrodes, wherein one of the separation electrodes is disposed at each end of the separation channel so the immunoglobulin complex migrates along the separation channel.

38. A method as recited in claim 37, wherein the separation potential applied is a dc voltage.

39. A method as recited in claim 37, further comprising the step of applying a detection potential across the detection electrodes, wherein the detection potential is an ac voltage having a predetermined peak-to-peak amplitude and a predetermined frequency.

40. A method as recited in claim 39, wherein the detection potential has a peak-to-peak amplitude of 400 V and a frequency of 50 kHz.

41. A method as recited in claim 39, further comprising the step of using the electronic conductometric detection circuit to detect the immunoglobulin complex as the complex migrates by the detection electrodes.

42. A method as recited in claim 33, wherein the body of the microchip further includes a pair of grooves formed in a surface of the body so as to cross the separation channel, and the detection electrodes are adhesive electrodes, so when the detection electrodes are placed on the microchip body the electrodes are placed to detachably cohere to a floor of each respective groove.

43. A method as recited in claim 33, wherein the microchip body is made of glass and the first sample and the second sample each include a run buffer and a surfactant to decrease adherence of the immunoglobulin complex to a wall in the body forming the separation channel.

44. A method as recited in claim 43, wherein the run buffer has a pH greater than an isoelectric point of the first immunoglobulin and an isoelectric point of the second immunoglobulin so as to decrease adherence of each immunoglobulin to the wall in the body forming the separation channel.

45. A method as recited in claim 41, wherein the time period between forming the immunoglobulin complex in the separation channel and detecting the immunoglobulin complex using the detection circuit is less than one minute.

46. A method as recited in claim 33, wherein the first immunoglobulin is IgM and the second immunoglobulin is IgG.

47. A capillary electrophoresis assembly comprising:
a holder including a frame for removably receiving a chip;
a capillary electrophoresis microchip dimensioned to fit onto the holder, and comprising a body and a separation channel defined in the body; and
a pair of detection electrodes integrated with an electronic conductometric detection circuit, wherein the detection electrodes are permanently affixed to the holder, wherein the assembly is assemblable by disposing the capillary electrophoresis microchip on the holder so the detection electrodes are disposed on the microchip body near the separation channel.

48. A capillary electrophoresis assembly as recited in claim 47, wherein the detection electrodes are affixed to the holder so when the microchip is assembled on the holder, the detection electrodes are disposed on an undersurface of the microchip.

49. A capillary electrophoresis assembly as recited in claim 47, wherein the holder further comprises an electrode support member attachable to the microchip body, and the detection electrodes are permanently affixed to the electrode support member so when the microchip is assembled on the holder, the electrode support member attaches to the microchip body and the detection electrodes are disposed on a top surface of the microchip.
